(19) United States
(12) Patent Application Publication
(10) Pub. No.: US 2023/0191353 A1
(43) Pub. Date: Jun. 22, 2023

(54) ACTIVE COATING BASED ON PICKERING EMULSIONS

(71) Applicant: The State of Israel, Ministry of Agriculture & Rural Development, Agricultural Research Organization, Rishon Lezion (IL)

(72) Inventors: Guy MECHREZ, Adi (IL); Karthik ANANTH MANI, Rishon Lezion (IL); Yafit ITZHAIK ALKOTZER, Holon (IL)

(21) Appl. No.: 17/950,788

(22) Filed: Sep. 22, 2022

Related U.S. Application Data
(63) Continuation of application No. PCT/IL2021/050344, filed on Mar. 25, 2021.
(60) Provisional application No. 63/000,150, filed on Mar. 26, 2020.

(51) Int. Cl. B01J 13/14; B01J 13/12; B01J 13/22

(52) U.S. Cl. CPC B01J 13/14; B01J 13/125; B01J 13/22

(57) ABSTRACT

A composition comprising an emulsion comprising a plurality of particles is provided. An article comprising a substrate, and a plurality of particles comprising a core and a shell, wherein the plurality of particles are in the form of a coating layer on the substrate is provided. Further, a method for coating a substrate, and a method for preparing the composition are provided.

### CROSS REFERENCE TO RELATED APPLICATIONS

This application is a Bypass Continuation of PCT Patent Application No. PCT/IL2021/050344 having International filing date of Mar. 25, 2021, which claims the benefit of priority to U.S. Provisional Patent Application No. 63/000,150 filed Mar. 26, 2020, entitled “ACTIVE COATING BASED ON PICKERING EMULSIONS” the contents of which are all incorporated herein by reference in their entirety.

### FIELD OF THE INVENTION

The present invention is in the field of Pickering emulsions.

### BACKGROUND OF THE INVENTION

Pickering emulsions are typically known as emulsions of any type, for example oil-in-water or water-in-oil, stabilized by solid particles in place of surfactants. Pickering emulsions are stabilized by nanoparticles (NPs) that are self-assembled typically at the oil-water interface and acts as a physical barrier.

### SUMMARY OF THE INVENTION

In one aspect of the invention, there is a particle, comprising a shell and a core, wherein the core comprises (i) 1% to 90% (w/w) of a viscoelastic polymer, and (ii) 0.1% to 50% (w/w) of an active agent and; the shell comprises hydrophobic nanoparticles in contact with the viscoelastic polymer, and wherein a w/w concentration of the viscoelastic polymer within the shell is between 5 to 50%.

In one embodiment, the particle is in a form of a hollow sphere.

In one embodiment, the shell comprises an inner portion facing the core and an outer portion facing an ambient.

In one embodiment, the inner portion, the outer portion or both comprise the viscoelastic polymer.

In one embodiment, the viscoelastic polymer has a glass transition temperature (Tg) above 30° C.

In one embodiment, the viscoelastic polymer is a viscous polymer having a viscosity at 25° C. between 30 and 200 cP.

In one embodiment, the active agent has a boiling temperature above 60° C.

In one embodiment, the particle has a diameter of 0.5 μm to 500 μm.

In one embodiment, the shell has a thickness of 10 nm to 100 μm.

In one embodiment, the particle comprises 1% to 90% (w/w) of the hydrophobic nanoparticles.

In one embodiment, the viscoelastic polymer comprises a polyacrylate-co-PVC, polysiloxane, polyisocyanate, polyvinylchloride (PVC), a vinyl-based polymer, polymetacrylate, polysilane, polysilazane, polyvinyl alcohol (PVA), poly (2ethyl-2-oxazoline), carboxymethyl cellulose (CMC), and dimethylsiloxane, or any copolymer or a combination thereof.

In one embodiment, the active agent comprises an essential oil, a herbicide, a pesticide, a fungicide, or any combination thereof.

In one embodiment, the hydrophobic nanoparticles comprises chemically modified metal oxide.

In one embodiment, the metal oxide comprises nanoclay, SiO₂, TiO₂, Al₂O₃, Fe₂O₃, ZnO, and ZrO or any combination thereof.

In one embodiment, the chemical modification comprises any of (C1-C20)alkyl, phenyl, thiol group, vinyl, fluoroalkyl, haloalkyl, halogen, epoxy, a cycloalkane, an alkene, a haloalkene, an alkyne, an ether, a silyl group, a siloxane group, and a thioether or any combination thereof.

In one embodiment, the ratio of the hydrophobic nanoparticles to the viscoelastic polymer within the particle is 1:5 to 5:1 (w/w).

In one embodiment, the ratio of the viscoelastic polymer to the active agent within the particle is 1:0.01 to 1:0.1 (w/w).

In one embodiment, the particle has a spherical shape, a quasi-spherical shape, a quasi-elliptical sphere, an irregular shape, or any combination thereof.

In another aspect, there is a composition comprising the particle of the invention and a solvent.

In one embodiment, the composition is selected from the group consisting of an emulsion, a dispersion, oil-in-oil emulsion, water-in-oil, and oil-in-water emulsion or any combination thereof.

In one embodiment, the solvent comprises an aqueous solvent, a lipophilic organic solvent and a polar organic solvent or any combination thereof.

In another aspect, there is an article comprising: a substrate, and (i) the particle of the invention or (ii) the composition of the invention.

In one embodiment, the particle comprises a plurality of particles.

In one embodiment, the plurality of particles is in a form of a coating.

In one embodiment, the particle is bound to the substrate.

In one embodiment, the substrate is selected from, a polymeric substrate, a glass substrate, a metallic substrate, a paper substrate, a brick wall, a sponge, a textile, a non-woven fabric, or wood.

In one embodiment, the polymeric substrate comprises a polyolefin.

In one embodiment, the coating layer is characterized by an average thickness of 100 nm to 500 μm.

In one embodiment, the coating layer is characterized by a water contact angle (WCA) in the range of 115° to 180°.

In one embodiment, the coating layer is characterized by a roll-off (RA) angle of less than 30°.

In one embodiment, the coating layer is stable at a temperature range of −100° C. to 200° C.

In one embodiment, the coating layer is characterized by a transparency of 30% to 100%.

In another aspect, there is a method for manufacturing the particle of the invention, comprising the steps of: providing a first solution comprising 1% to 50% (w/w) of the viscoelastic polymer and 0.1 to 90% (w/w) of the active agent; providing a second solution comprising 0.1 to 10% w/w of the hydrophobic nanoparticles; and mixing the first solution and the second solution under appropriate conditions, thereby obtaining the particles dispersed within a solvent.

In one embodiment, the solvent independently comprises an organic solvent, an aqueous solvent or both.

In one embodiment, the method further comprises evaporating the solvent.

In one embodiment, the evaporating is by applying any of vacuum, heat, or both.

In one embodiment, the organic solvent comprises acetone, methyl ethyl ketone (MEK), n-methyl-2-pyrrolidone (NMP), methyl-isobutylketone, mineral oil, ethyl acetate, and a nitrile, or any combination thereof.

In one embodiment, the organic solvent has a boiling point less than a boiling point of the hydrophobic active agent.

In one embodiment, the mixing is high shear mixing, ultrasonication, overhead stirring, homogenizing, or a combination thereof.

In one embodiment, the ratio of the first solution to the second solution is 5:1 to 1:5 (w/w).

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Further embodiments and the full scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 represents a schematic illustration of a Pickering emulsion;

FIGS. 2A-2C are micrographs showing encapsulation of Thymol within a coating comprising colloidosomes array. The coating layer has been prepared by applying and subsequent drying on top of a glass slide an exemplary emulsion of the invention comprising 4 wt % hydrophobic silica, 10 wt % a polymer (a mixture of polyacrylate and polyvinylchloride (PVC)), 1:1 volume fraction of oil and acetone. FIGS. 2A and 2B are optical images of the encapsulated Thymol within the coating layer. FIG. 2C is a confocal microscopy image of encapsulated Thymol within the coating layer (labelled with Nile red).

FIGS. 3A-3D SEM images, at different magnitudes, of an exemplary coating of the invention on top of a polypropylene (PP) substrate (PP film). The coating layer has been prepared by applying on the PP substrate an exemplary emulsion of the invention comprising 5 wt % of hydrophobic silica, 5 wt % polymer (a mixture of polyacrylate and PVC) and 6:4 volume fraction of oil and acetone.

FIGS. 4A-4D are micrographs representing cryo-SEM images of exemplary dry particles (colloidosome) of the invention on top of a glass slide (FIG. 4A) and optical (FIG. 4C) and confocal microscopy image (FIG. 4D) of an exemplary emulsion of the invention consisting of 3-5 wt % of hydrophobic silica, 5 wt % polymer (a mixture of polyacrylate and PVC) and 1:1 volume fraction of oil and acetone (labelled with Nile red). FIG. 4B represents a cryo-SEM image of a dry particle obtained by applying and subsequent drying on top of a glass slide an emulsion consisting of 3-5 wt % of hydrophobic silica, and 1:1 volume fraction of oil and acetone.

FIGS. 5A-5C are micrographs representing a SEM image (FIG. 5A) and a confocal microscopy image (FIG. 5B) of PP film coated by an exemplary coating of the invention prepared by applying and subsequent drying an emulsion comprising 4 wt % hydrophobic silica, 10 wt % polymer (a mixture of polyacrylate and PVC), 1:1 fraction of oil and acetone (labelled with Nile red). FIG. 5C represents a combined optical and confocal images of encapsulated Thymol in the abovementioned emulsion applied on the glass slide labelled with Nile red.

FIGS. 6A-6I are micrographs showing microscopy images (confocal microscopy images FIGS. 6A-6C; and Cryo-SEM images FIGS. 6D-6F) of an exemplary emulsion of the invention comprising 3 wt % of hydrophobic silica, equal volume (1:1) fraction of oil and acetone, and 5 wt % polymer (PVA polyacrylate mixture). FIG. 6G-6I are SEM images of an exemplary coating of the invention prepared by applying on the glass slide an exemplary emulsion of the invention comprising 5 wt % of hydrophobic silica, 5 wt % polymer (PVA polyacrylate mixture) and 6:4 fraction of oil and acetone. The acetone phase has been labelled with Nile red. A core-shell structure of the particle comprising a polymeric network in contact with the shell is shown (FIGS. 6D-6F).

FIGS. 7A-7C are micrographs showing a confocal microscopy analysis of the emulsion comprising 2% w/w hydrophobic silica nanoparticles and 2% w/w PVA in 70:30 mineral oil/water emulsion (7A and 7B). Confocal images confirm encapsulation of a water-soluble active agent within the particle. FIG. 7C represents a HRSEM analysis of a coating prepared by applying on the glass slide the abovementioned emulsion.

FIGS. 8A-8C are micrographs showing encapsulation of Thymol in oil in an exemplary acetone/oil Pickering emulsion of the invention. FIG. 8A shows optical images of encapsulated Thymol in emulsion. FIG. 8B shows confocal images of encapsulated Thymol in emulsion. FIG. 8C shows an overlay of optical and confocal images of encapsulated Thymol in emulsion.

FIGS. 9A-9C are micrographs showing encapsulation of Thymol within a coating comprising colloidosomes array. FIG. 9A shows optical images of encapsulated Thymol within the coating. FIG. 9B shows confocal images of encapsulated Thymol within the coating. FIG. 9C shows an overlay of optical and confocal images of encapsulated Thymol within the coating. The coating layer has been prepared by applying and subsequent drying on a glass slide an exemplary emulsion of the invention comprising 3 wt % of hydrophobic silica, 5 wt % polymer (a mixture of polyacrylate and PVA) and 1:1 volume fraction of oil and acetone.

FIGS. 10A-10F are micrographs showing a coating on top of a non-woven Avgol® polymeric substrate. The coating layer has been prepared by applying and subsequent drying on the non-woven substrate an exemplary emulsion of the invention comprising 3 wt % of hydrophobic silica, 5 wt % polymer (a mixture of polyacrylate and PVA), Thymol and 1:1 volume fraction of oil and acetone. FIGS. 10A-10C show SEM images (at different magnification) of untreated Avgol® substrate. FIGS. 10D-10F show SEM images (at different magnification) of the coatings on top of Avgol® substrate.

FIG. 11 is a graph representing a release curve of the thymol from Avgol® sheets coated by applying and subsequent drying on the non-woven substrate an exemplary emulsion of the invention comprising 3 wt % of hydrophobic silica, 5 wt % polymer (a mixture of polyacrylate and PVA), Thymol and 1:1 volume fraction of oil and acetone.

FIG. 12 represents an illustration of colloidosome array-based coating.

### DETAILED DESCRIPTION OF THE INVENTION

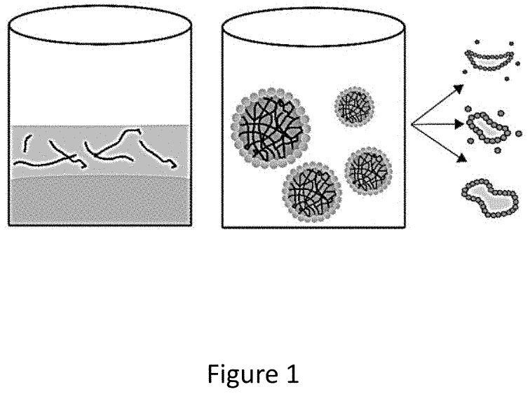

According to some embodiments, the present invention provides a composition comprising an emulsion comprising a plurality of particles. In some embodiments, the composition comprises an oil-in-oil (O/O) Pickering emulsion. In some embodiments, the composition comprises a solvent in oil Pickering emulsion. Reference is made to FIG. 1, which presents a schematic illustration of an O/O Pickering emulsion, according to some embodiments of the present invention. In some embodiments, the composition comprises a water-in-oil (W/O) Pickering emulsion. In some embodiments, the composition comprises an oil-in-water (O/W) Pickering emulsion. In some embodiments, the composition comprises an oil-in-oil (O/O) Pickering emulsion, wherein the minor phase (or a solvent within the core) is a ketone solvent.

The emulsion according to the present invention comprises core-shell particles dispersed within the major phase, wherein the core-shell particles comprise: (i) a shell comprising hydrophobic nanoparticles, and (ii) a core comprising or encapsulating a polymer. In some embodiments, the emulsions are used as active coatings. In some embodiments, the emulsion of the invention comprises core-shell particles comprising: (i) a shell comprising hydrophobic metal oxide nanoparticles, and (ii) a core comprising or encapsulating a polymer. In some embodiments, the emulsions are used as active coatings.

According to some embodiments, the present invention provides a composition comprising an emulsion comprising a plurality of core-shell particles, the core-shell particles have a diameter of between 0.5 μm and 500 μm, and comprise a shell having a thickness of 10 nm to 100 μm, wherein the shell comprises hydrophobic nanoparticles (e.g. metal oxide based hydrophobic nanoparticles). In some embodiments, the shell is a single layer shell. In some embodiments, the hydrophobic nanoparticles are in the interface between a major phase and a minor phase, thereby stabilizing any of the emulsions described herein. In some embodiments, the core-shell particles comprise a polymer. In some embodiments, the polymer is a thermoplastic or a viscoelastic polymer. In some embodiments, the core-shell particles comprise a core encapsulating 0.1% to 50% weight per weight (w/w) of an active agent.

According to some embodiments, the present invention provides an article comprising a substrate in contact with a plurality of core-shell particles, wherein the plurality of core-shell particles form a coating layer on a surface of the substrate. In some embodiments, the core-shell particles comprise a viscoelastic polymer and an active agent encapsulated within the core.

In some embodiments, the coating layer is an active coating. In some embodiments, the coating layer on top of the substrate is formed by applying the emulsion described herein on a surface of the substrate, and subsequently drying the emulsion. In some embodiments, the article comprising the coating layer is characterized by a slow release, wherein the slow release is referred to the release of the active agent encapsulated within the core-shell particle of the invention.

In some embodiments, the release profile of the active agent is predetermined by the chemical nature of the polymer, amount of polymer used and physical parameters of the coating layer (e.g. thickness, shape, etc.). In some embodiments, the polymer (e.g. chemical composition of the polymer and/or molecular weight) predetermines the mass transfer rate of the active agent.

In some embodiments, the polymer of the invention enhances and/or facilitates binding of the plurality of core-shell particles to a surface of the substrate. In some embodiments, the polymer of the invention (e.g. viscoelastic polymer) predetermines the stability and/or the thickness of the coating layer. The structure and properties of the coating layer can be tuned by modifying the amount of polymer within the particle. In some embodiments, the coating layer is substantially stable (e.g. at least 90% of the coating layer is stably bound to the substrate, and/or maintains at least 90% of: surface roughness, structural form, or chemical composition thereof) upon mechanical abrasion.

### The Composition

In one aspect of the invention, there is a composition comprising an emulsion or a dispersion. In some embodiments, the emulsion is an O/O Pickering emulsion. In some embodiments, the emulsion is a W/O Pickering emulsion. In some embodiments, the emulsion is an O/W Pickering emulsion. In some embodiments, the composition of the invention is or comprises a stable Pickering emulsion. In some embodiments, the composition of the invention is or comprises a stable O/O Pickering emulsion.

In some embodiments, the composition comprises an emulsion or dispersion, comprising a plurality of core-shell particles dispersed in a major phase. In some embodiments, the core-shell particles comprise a liquid core stabilized or encapsulated by a shell. In some embodiments, the core-shell particles are in the form of droplets comprising a liquid core at least partially surrounded or encapsulated by the shell comprising hydrophobic metal oxide nanoparticles. In some embodiments, the composition of the invention comprises a Pickering emulsion, comprising the core-shell particles stably dispersed within the major phase. In some embodiments, the major phase is or comprises an oil.

As used herein, the term “Pickering emulsion” refers to an emulsion that utilizes solid hydrophobic nanoparticles particles (e.g. hydrophobic metal oxide nanoparticles) as a stabilizer to stabilize liquid droplets dispersed within a liquid, also referred to as a major phase.

As used herein, the term “emulsion” refers to a combination of at least two fluids, where one of the fluids is present in the form of droplets stably dispersed in the other fluid. The term “emulsion” includes microemulsions and/or nanoemulsions.

As used herein, the term “fluid” refers to a substance that tends to flow and to conform to the outline of its container, i.e., a liquid, a gas, a viscoelastic fluid, etc. Typically, fluids are materials that are unable to withstand a static shear stress, and when a shear stress is applied, the fluid experiences a continuing and permanent distortion. The fluid may have any suitable viscosity that permits flow. If two or more fluids are present, each fluid may be independently selected among essentially any fluids (liquids, gases, and the like) by those of ordinary skill in the art, by considering the relationship between the fluids. In some cases, the droplets may be contained within a carrier fluid, e.g., a liquid or a liquid oil.

In another aspect, there is an emulsion comprising a plurality of core-shell particles dispersed within the major phase, wherein each core-shell particle comprises a shell and a core; and wherein: the core is a liquid comprising between 1% and 50% (w/w) of a viscoelastic polymer including any range between; and the shell comprises a plurality of hydrophobic metal oxide nanoparticles stabilizing and/or at least partially encapsulating the core. In some embodiments, the shell of the core-shell particle of the invention comprises hydrophobic metal oxide nanoparticles in contact with the viscoelastic polymer. In some embodiments, the shell of the core-shell particle of the invention comprises hydrophobic metal oxide nanoparticles facing the core comprising the viscoelastic polymer. In some embodiments, the core-shell particle of the invention comprise a liquid core at least partially surrounded or encapsulated by the shell, wherein the core and the shell are as described herein.

In some embodiments, the emulsion of the invention comprises a plurality of core-shell particles dispersed within the major phase, wherein each core-shell particle comprises a shell and a core; and wherein: the core is a liquid comprising (i) between 1% and 50%, between 1% and 4%, between 5% and 50%, between 1% and 5%, between 50% and 90% (w/w) of a viscoelastic polymer including any range between; (ii) between 50% and 99% (w/w) of an organic solvent or of an aqueous solvent; and optionally between 0.1% and 50% (w/w) of an active agent; and wherein the shell comprises a plurality of hydrophobic metal oxide nanoparticles.

In some embodiments, the emulsion of the invention comprises a plurality of core-shell particles dispersed within the major phase, wherein each core-shell particle comprises a shell and a core; and wherein: the core is a liquid comprising (i) between 1% and 50%, between 1% and 4%, between 5% and 50%, between 1% and 5%, between 50% and 90% (w/w) of a viscoelastic polymer including any range between; (ii) between 50% and 99% (w/w) of an organic solvent or of an aqueous solvent; and optionally between 0.1% and 50% (w/w) of an active agent; and wherein the shell comprises a plurality of hydrophobic metal oxide nanoparticles and between 5 and 50%, between 5 and 10%, between 0.5 and 5%, between 10 and 20%, between 20 and 50% including any range between of the viscoelastic polymer by weight of the shell.

In some embodiments, the term “core-shell particle” and the term “particle” including any grammatical form thereof, are used herein interchangeably.

In some embodiments, the emulsion of the invention comprises a plurality of particles dispersed within the major phase, wherein each particle comprises a liquid core. In some embodiments, the particle is in a form of a droplet.

In some embodiments, the droplets or the core-shell particles of the invention have a diameter of 1 μm to 100 μm, 5 μm to 100 μm, 10 μm to 100 μm, 50 μm to 100 μm, 1 μm to 80 μm, 10 μm to 80 μm, 50 μm to 80 μm, 1 μm to 10 μm, 5 μm to 10 μm, 1 μm to 50 μm, 10 μm to 50 μm, 5 μm to 50 μm, or 1 μm to 5 μm, including any range therebetween. In some embodiments, the term “diameter” refers to the average diameter, as described herein.

As used herein, the term “droplet” refers to an isolated portion of a first fluid that is surrounded by a second fluid. It is to be noted that a droplet is not necessarily spherical; but may assume other shapes as well, for example, depending on the external environment. In some embodiments, the droplet has a minimum cross-sectional dimension that is substantially equal to the largest dimension of the channel perpendicular to fluid flow in which the droplet is located. In some cases, the droplet may be a vesicle, such as a liposome, a colloidosome, or a polymersome. The fluidic droplets may have any shape and/or size. Typically, monodisperse droplets are of substantially the same size. The shape and/or size of the fluidic droplets can be determined, for example, by measuring the average diameter or other characteristic dimension of the droplets. The “average diameter” of a plurality or series of droplets is the arithmetic average of the average diameters of each of the droplets. Those of ordinary skill in the art will be able to determine the average diameter (or other characteristic dimension) of a plurality or series of droplets, for example, using laser light scattering, microscopic examination, or other known techniques. The average diameter of a single droplet, in a non-spherical droplet, is the diameter of a perfect sphere having the same volume as the non-spherical droplet. In some embodiments, the average diameter of a droplet (and/or of a plurality or series of droplets) is, 5 μm to 100 μm, 5 μm to 50 μm, 1 μm to 50 μm, including any range therebetween. In some embodiments, the average diameter of a droplet is a wet diameter (i.e. a particle dimeter within a solution).

In some embodiments, the particle is a core-shell particle. In some embodiments, the shell comprises an inner portion facing the core and an outer portion facing an ambient.

In some embodiments, the inner portion is in contact with the core. In some embodiments, the inner portion is bound to the core. In some embodiments, the shell stabilizes the core. In some embodiments, the shell encapsulates the core.

In some embodiments, the composition of the invention comprises an emulsion or dispersion, comprising a plurality of particles, having a diameter of 5 μm to 100 μm, the particles comprise: (i) a shell having a thickness of 5 nm to 100 nm, 5 nm to 10 nm, 10 nm to 30 nm, 30 nm to 50 nm, including any range between and comprising between 50 and 99%, between 50 and 60%, between 60 and 70%, between 70 and 90%, between 90 and 95%, between 95 and 99%, by weight of metal oxide hydrophobic metal oxide nanoparticles including nay range between, and optionally comprising between 1 and 30% of the polymer of the invention; and (ii) a liquid core comprising the polymer of the invention dissolved in an organic solvent, wherein a w/w concertation of the polymer within the liquid core is between 1 and 50%, between 1 and 10%, between 10 and 20%, between 20 and 30%, between 30 and 50%, including nay range between.

In some embodiments, the shell has a thickness in the range of 5 nm to 50 nm, 15 nm to 50 nm, 30 nm to 50 nm, 1 nm to 50 nm, 2 nm to 50 μm, 5 μm to 10 μm, 10 nm to 50 nm, 5 nm to 30 nm, 15 nm to 30 nm, 1 nm to 20 μm, 2 nm to 20 nm, 5 nm to 20 nm, or 10 nm to 20 nm, including any range therebetween. In some embodiments, the shell thickness is quantified using scanning electron microscopy.

In some embodiments, the liquid core of the particle of the invention comprises an organic solvent and the viscoelastic polymer of the invention dissolved therewithin. In some embodiments, the liquid core of the particle of the invention comprises an aqueous solvent and the viscoelastic polymer of the invention dissolved therewithin. In some embodiments, the viscoelastic polymer is stably dissolved within the solvent (e.g. organic solvent or an aqueous solvent) comprising the core, wherein stably refers to a physically stable solution (e.g. substantially devoid of precipitation, aggregation, phase separation, etc.).

In some embodiments, a volume of the liquid core comprises at most 95%, at most 90%, at most 85%, at most 80%, at most 75%, at most 70%, at most 60%, at most 50%, at most 40%, at most 30%, at most 20% v/v of a fluid (such as an aqueous solution, or an organic solvent).

### Polymer

In some embodiments, the viscoelastic polymer remains stably dissolved within the solvent during the formation of the emulsion of the invention, and/or upon storage thereof for a time period ranging between 1 week (w) and 5 years (y), between 1 and 5 w, between 5 and 10 w, between 10 and 15 w, between 15 and 20 w, between 1 and 3 months (m), between 3 and 5 m, between 5 and 10 m, between 5 and 12 m, between 3 and 12 m, between 3 and 6 m, between 6 and 12 m, between 1 and 2 y, between 2 and 3 y, between 3 and 4 y, between 4 and 5 y, including any range between. As used herein, the term “storage” refers to normal storage conditions comprising a temperature of between 10 and 60° C., between 10 and 20° C., between 20 and 40° C., between 40 and 60° C., and a relative humidity of between 10 and 100%, including any range between.

In some embodiments, the polymer of the invention (e.g. viscoelastic polymer) is soluble within the organic solvent of the invention. In some embodiments, the polymer of the invention (e.g. viscoelastic polymer) has a solubility within the organic solvent of at least 0.5 g/L, at least 1 g/L, at least 3 g/L, at least 5 g/L, at least 10 g/L, at least 20 g/L, at least 50 g/L, at least 100 g/L, including any range between. In some embodiments, the polymer of the invention (e.g. viscoelastic polymer) is soluble in a polar organic solvent. In some embodiments, the polymer of the invention (e.g. viscoelastic polymer) is soluble in an organic solvent of the invention, wherein the organic solvent of the invention is or comprises a ketone (e.g. acetone, MEK, etc.).

In some embodiments, the viscoelastic polymer is soluble within the aqueous solvent of the invention. In some embodiments, the polymer of the invention (e.g. viscoelastic polymer) has a solubility within the aqueous solvent of at least 0.5 g/L, at least 1 g/L, at least 3 g/L, at least 5 g/L, at least 10 g/L, at least 20 g/L, at least 50 g/L, at least 100 g/L, including any range between.

In some embodiments, the polymer of the invention (e.g. viscoelastic polymer) has a low solubility within the major phase (e.g. oil), e.g., less than 1 g/L, less than 0.5 g/L, less than 0.1 g/L, less than 0.01 g/L, including any range between.

In some embodiments, the viscoelastic polymer and the active agent comprise up to 80%, up to 85%, up to 90%, up to 92%, up to 95%, up to 97%, up to 99%, up to 98%, up to 96% by dry weight of the particle's core (e.g. calculated after evaporation of the organic or aqueous solvent form the particle's core). In some embodiments, the viscoelastic polymer and the active agent comprise between 80 and 99.9% w/w by dry weight of the particle core. In some embodiments, the viscoelastic polymer and the hydrophobic metal oxide nanoparticles comprise up to 80%, up to 85%, up to 90%, up to 92%, up to 95%, up to 97%, up to 99%, up to 98%, up to 96% w/w by dry weight of the particle shell. In some embodiments, the viscoelastic polymer and the hydrophobic metal oxide nanoparticles comprise between 80 and 99.9% w/w by dry weight of the particle shell. In some embodiments, the term “hydrophobic metal oxide nanoparticle” and the term “hydrophobic inorganic nanoparticle” are used herein interchangeably.

In some embodiments, the polymer of the invention is a viscoelastic polymer. In some embodiments, the polymer of the invention is a thermoplastic polymer. In some embodiments, the polymer of the invention has a glass transition temperature (Tg) above 30° C. In some embodiments, the polymer of the invention is in an amorphous state at a temperature between 10 and 60° C., between 10 and 20° C., between 20 and 30° C., between 30 and 40° C., between 40 and 50° C., between 50 and 60° C. including any range or value therebetween.

In some embodiments, the polymer of the invention is characterized by a crystallinity of less than 40%, less than 30%, less than 20%, less than 15%, less than 10%, less than 5%, less than 3%, less than 2%, less than 1% at a temperature between 10 and 30° C.

In some embodiments, the polymer of the invention is a viscous polymer having a viscosity at 25° C. between 30 and 200 cP, 30 and 50 cP, 50 and 60 cP, 60 and 80 cP, 80 and 100 cP, 100 and 150 cP, 150 and 200 cP including any range or value therebetween.

In some embodiments, the viscoelastic polymer of the invention is chemically stable (e.g. maintains at least 90% of its chemical composition) at a temperature of 100° C., of 80° C., of 90° C., of 70° C., of 60° C., of 50° C., of 40° C. including any range or value therebetween.

In some embodiments, the polymer of the invention has an affinity to the hydrophobic metal oxide nanoparticle. In some embodiments, the polymer of the invention stably adheres to the hydrophobic metal oxide nanoparticle in a dry or solid state.

In some embodiments, the polymer is characterized by elasticity. In some embodiments, the elasticity refers to an elastic modulus. In some embodiments, the term “elastic modulus” refers to Young's modulus. In some embodiments, the term “elastic modulus” is determined by response of a material to application of tensile stress (e.g., according to procedures known in the art).

In some embodiments, the elasticity refers to Flexural modulus. As used herein and in the art, the flexural modulus (also referred to as “bending modulus”) is the ratio of stress to strain in flexural deformation, or the tendency for a material to bend. Flexural modulus may be determined from the slope of a stress-strain curve.

In some embodiments, the viscoelastic polymer is characterized by a property is selected from, without being limited thereto, Young's modulus, tensile strength, fracture strain, yield point, toughness, abrasion resistance, stiffness, creep resistance, work-to-failure, stress and percentage of elongation.

As used herein, the term “thermoplastic” refers to a class of polymers that can be softened and melted by the application of heat, and can be processed either in the heat-softened state (e.g. by thermoforming) or in the liquid state (e.g. by extrusion and injection molding). Thermoplastic polymers solidify upon cooling, maintaining their shape.

As used herein throughout, the term “polymer” describes an organic substance composed of a plurality of repeating structural units (backbone units) covalently connected to one another. In some embodiments, the thermoplastic polymer comprises a polyacrylate, polysiloxane, polyethylene, polyisocyanate, polyurethane, fluorinated polymer, perfluorinated polymer, Teflon, Teflon PTFE, polyvinylchloride, polydimethylsiloxane, polystyrene, polytetrafluoroethylene, or any combination thereof.

In some embodiments, the viscoelastic polymer is characterized by an HLB of between 6 and 18, between 6 and 10, between 10 and 12, between 12 and 15, between 15 and 18, including any range between.

In some embodiments, the viscoelastic polymer comprises a polyacrylate-co-PVC, polysiloxane, polyisocyanate, polyvinylchloride (PVC), a vinyl-based polymer, polymetacrylate, polysilane, polysilazane, polyvinyl alcohol (PVA), poly (2ethyl-2-oxazoline), carboxymethyl cellulose (CMC), and dimethylsiloxane, or any copolymer or a combination thereof. In some embodiments, the viscoelastic polymer comprises a polyacrylate, a polymetacrylate, a polymethylmetacrylate including any copolymer or a combination thereof. In some embodiments, the viscoelastic polymer comprises PVA or a copolymer thereof.

In some embodiments, the liquid core of the particle of the invention comprises between 1% and 50%, between 1% and 2%, between 2% and 5%, between 5% and 10%, between 10% and 15%, between 15% and 20%, between 20% and 30%, between 30% and 50% (w/w) of the viscoelastic polymer of the invention, including any range between.

### Solvent

In some embodiments, the liquid core of the particle of the invention is composed of a solvent (an aqueous solvent or an organic solvent of the invention), also referred to herein as a minor phase. In some embodiments, the minor phase comprises a solvent immiscible with the major phase (e.g. oil). In some embodiments, the liquid core of the particle of the invention comprises an organic solvent immiscible with the major phase (e.g. oil).

In some embodiments, the minor phase comprises a polar organic solvent. In some embodiments, the organic solvent is or comprises a ketone. In some embodiments, the organic solvent comprises any of: methyl ethyl ketone (MEK), acetone, n-methyl-2-pyrrolidone (NMP), methylisobutylketone, dichloromethane, or any combination thereof. In some embodiments, the minor phase comprises a ketone solvent. In some embodiments, the organic solvent of the invention comprises a ketone solvent.

In some embodiments, the minor phase (e.g. ketone solvent) is immiscible with the major phase (e.g. oil) and is capable of dissolving the polymer of the invention, and optionally capable of dissolving the active agent, wherein dissolving is so as to result in a concertation of the polymer and/or of the active agent within the solvent of at least 1 g/L, at least 3 g/L, at least 5 g/L, at least 10 g/L, at least 20 g/L, at least 50 g/L, at least 100 g/L, including any range between.

In some embodiments, the minor phase or the core (e.g. the liquid core) of the particle of the invention comprises an organic solvent of the invention (e.g. a ketone solvent), wherein the organic solvent is between 50% and 99%, between 50% and 60%, between 60% and 70%, between 70% and 80%, between 80% and 90%, between 90% and 95%, between 95% and 99%, by weight of the liquid core including any range between.

In some embodiments, the core-shell particle of the invention comprises a liquid core comprising a ketone solvent and the polymer of the invention dissolved therewithin. In some embodiments, at least 80%, at least 90%, at least 95%, at least 97%, at least 99% by weight of the liquid core of the particle of the invention is composed of the ketone solvent and the polymer of the invention. In some embodiments, the ketone solvent comprises any of: MEK, acetone, acetophenone, butanone, cyclopentanone, cyclohexanone, ethyl isopropyl ketone, methyl isobutyl ketone, methyl isopropyl ketone, 2-pentanone, 3-pentanone, 3-methyl-2-pentanone, or any combination thereof.

In some embodiments, the core-shell particle of the invention comprises a liquid core comprising a ketone solvent (e.g. acetone or MEK) comprising between 0.1 and 35% w/w of a polymer of the invention dissolved therewithin, wherein the polymer of the invention is or comprises PVA, PVC, and polyacrylate or any mixture and/or copolymer thereof.

### Active Agent

In some embodiments, the minor phase comprises an active agent. In some embodiments, the emulsion of the invention comprises an active agent dissolved in the minor phase. In some embodiments, the core of the core-shell particle of the invention encapsulates an active agent.

In some embodiments, the core (e.g. the liquid core) of the particle further comprises between 0.1% and 50%, between 0.1% and 5%, between 5% and 10%, between 10% and 20%, between 20% and 30%, between 30% and 50% (w/w) of the active agent. In some embodiments, the particle core comprises between 0.1% and 50%, between 0.1% and 5%, between 5% and 10%, between 10% and 20%, between 20% and 30%, between 30% and 50% (v/v) of the active agent.

In some embodiments, the active agent has a boiling temperature greater than the boiling temperature of the organic solvent. In some embodiments, the active agent has a boiling temperature greater than the boiling temperature of the solvent of the invention (e.g. organic solvent) by at least 5° C., at least 10° C., at least 15° C., at least 20° C., at least 30° C., including any range between.

In some embodiments, the active agent has a boiling temperature of more than 40° C., of more than 50° C., of more than 55° C., of more than 60° C., of more than 65° C., of more than 70° C., of more than 80° C., of more than 90° C., of more than 100° C., including any range between.

In some embodiments, the active agent is water-soluble. In some embodiments, the active agent is lipophilic. In some embodiments, the active agent is water-insoluble. In some embodiments, the water-soluble active agent has solubility in an aqueous solvent of more than 10 g/L. In some embodiments, the active agent is soluble in the minor phase (e.g. ketone solvent). In some embodiments, the active agent has solubility within the minor phase (e.g. ketone solvent) of at least 1 g/L, at least 3 g/L, at least 5 g/L, at least 10 g/L, at least 20 g/L, at least 50 g/L, at least 100 g/L, including any range between.

In some embodiments, the active agent comprises an essential oil, a herbicide, a pesticide, a fungicide, or any combination thereof.

As used herein, the term “active agent” refers to any type of material that can be encapsulated in the core and retain plant protective qualities. In some embodiments, the active agent has anti-fungal, anti-microbial, anti-insect, anti-viral, anti-mold, or plant protective qualities. In some embodiments, the active agent functions as a pesticide. In some embodiments, the active agent comprises a pesticide, a herbicide, a fragrance, a fungicide or any combination thereof. In some embodiments, the active agent comprises a plurality of active agents, wherein the active agents are as described herein.

In some embodiments, the active agent is lipophilic. In some embodiments, the active agent is an essential oil. In some embodiments, essential oil is thymol. In some embodiments, the essential oil is carvacrol. In some embodiments, the active agent is a mixture of thymol and carvacrol. In some embodiments, the active agent is a combination of more than one essential oil.

In some embodiments, the core-shell particle of the invention comprises a liquid core comprising a ketone solvent (e.g. acetone or MEK) comprising (i) between 0.5 and 35% w/w of a polymer of the invention dissolved therewithin, and (ii) between 0.01 and 50% w/w of an active agent dissolved therewithin; wherein the polymer of the invention is or comprises PVA, PVC, polyacrylate or a mixture thereof.

### Shell

In some embodiments, the core-shell particle of the invention comprises a core (e.g. a liquid core) at least partially surrounded or enclosed by a shell, wherein the core and the shell are as described herein. In some embodiments, the inner portion of the shell is in contact with the core. In some embodiments, the inner portion is bound to the core. In some embodiments, the shell stabilizes the core. In some embodiments, the shell at least partially encapsulates the core.

In some embodiments, the shell of the core-shell particle comprises a plurality of hydrophobic metal oxide nanoparticles. In some embodiments, the shell of the core-shell particle comprises a plurality of hydrophobic metal oxide nanoparticles in contact with the viscoelastic polymer. In some embodiments, the viscoelastic polymer forms an intertwined network within the particle (e.g. a droplet or a dry particle). In some embodiments, the viscoelastic polymer forms an intertwined network within the shell of the particle. In some embodiments, the viscoelastic polymer forms an intertwined network within the shell and/or within the core of the particle.

In some embodiments, the shell is stabilized by the polymer. In some embodiments, the polymer is a viscoelastic polymer. In some embodiments, the shell comprises the viscoelastic polymer bound to the hydrophobic metal oxide nanoparticles. In some embodiments, the hydrophobic metal oxide nanoparticles are adhered to the viscoelastic polymer. In some embodiments, the inner portion of the shell facing the core comprise the hydrophobic metal oxide nanoparticles bound or adhered to the viscoelastic polymer. In some embodiments, the hydrophobic metal oxide nanoparticles are held together by the viscoelastic polymer. In some embodiments, a portion of the viscoelastic polymer enhances the stability of the shell.

In some embodiments, the inner portion of the shell is bound or in contact with the polymeric portion of the core. In some embodiments, the shell is bound or in contact with the polymeric portion of the core. In some embodiments, the inner portion of the shell, the outer portion of the shell or both comprise the viscoelastic polymer.

In some embodiments, the shell is substantially devoid of an additional particle. In some embodiments, the shell is substantially devoid of an additional polymer. In some embodiments, the shell is substantially devoid of the polymer of the invention consisting essentially of hydrophobic metal oxide nanoparticles.

In some embodiments, the shell comprises between 10% and 99%, between 10% and 20%, between 20% and 30%, between 30% and 50%, between 50% and 60%, between 60% and 70%, between 70% and 80%, between 80% and 90%, between 90% and 99%, (w/w) of the hydrophobic metal oxide nanoparticles.

In some embodiments, the particle of the invention comprises between 1% and 90%, between 10% and 99%, between 10% and 20%, between 20% and 30%, between 30% and 50%, between 50% and 60%, between 60% and 70%, between 70% and 80%, between 80% and 90%, between 90% and 99% (w/w) of the hydrophobic metal oxide nanoparticles.

In some embodiments, at least a portion of the polymer of the invention is located within the shell of the core-shell particle. In some embodiments, the polymer of the invention is located within the core and within the shell of the core-shell particle.

In some embodiments, the w/w concentration of the viscoelastic polymer within the shell is between 1 to 50%, between 1 to 5%, between 5 to 10%, between 10 to 20%, between 20 to 30%, between 30 to 40%, between 40 to 50%, including any range therebetween.

In some embodiments, the viscoelastic polymer is at least partially located within the inner portion and/or within the outer portion of the shell. In some embodiments, between 1 and 20% by weight of the viscoelastic polymer is located within the inner portion and/or within the outer portion of the shell.

In some embodiments, the viscoelastic polymer and the hydrophobic metal oxide nanoparticles comprise up to 80%, up to 85%, up to 90%, up to 92%, up to 95%, up to 97%, up to 99%, up to 98%, up to 96% w/w of the particle's shell. In some embodiments, the viscoelastic polymer and the hydrophobic metal oxide nanoparticles comprise up to 80%, up to 85%, up to 90%, up to 92%, up to 95%, up to 97%, up to 99%, up to 98%, up to 96% w/w of the dry matter content (e.g. upon evaporation of the major phase and of the minor phase) of the composition of the invention.

In some embodiments, the shell of the particle of the invention comprises a plurality of hydrophobic metal oxide nanoparticles. In some embodiments, the plurality of hydrophobic metal oxide nanoparticles are the same. In some embodiments, the shell of the particle of the invention comprises different hydrophobic metal oxide nanoparticles. In some embodiments, the outer surface of the nanoparticles is hydrophobic. In some embodiments, the hydrophobic metal oxide nanoparticles comprise metal oxide particles. In some embodiments, the hydrophobic metal oxide nanoparticles comprise chemically modified metal oxide particles.

In some embodiments, the nanoparticles comprise metal oxide particles having a chemical modification (e.g. a hydrophobic group attached thereto). In some embodiments, the metal oxide nanoparticles comprise a metal oxide. In some embodiments, the metal oxide nanoparticles are metal oxide-based particles. In some embodiments, the metal oxide nanoparticles are selected from the group consisting of silica, titanium oxide, clay, and any combination thereof.

In some embodiments, hydrophobic metal oxide nanoparticles are selected from fluorinited-hydrophobic nanoparticles, fluoroalkylated-hydrophobic nanoparticles, silylated-hydrophobic nanoparticles, or any combination thereof.

Non-limiting examples of silylalted-hydrophobic nanoparticles include metal oxide nanoparticles modified with silyl, methyl silyl, dimethyl silyl, (C1-C₄) alkylsilyl, (C1-C20) linear alkyl silyl, (C1-C20) branched alkyl silyl, aromatic silane, halosilyl, halo(C1-C20)alkylsilyl, haloalkylsilyl, fluorinated (C1-C20) alkyl silyl, and (C1-C20) dialkyl silyl or a combination thereof.

As used herein, the term “C1-C4” refers to an optionally modified alkyl chain comprising 1, 2, 3, or 4 carbon atoms including any range between.

As used herein, the term “C1-C4” refers to an optionally modified alkyl chain comprising between 1 and 4, between 4 and 6, between 6 and 8, between 8 and 10, between 10 and 14, between 14 and 16, between 16 and 20 carbon atoms including any range between.

As used herein, the term “alkyl” comprises an alkane, an alkene, or an alkyne.

The term “silica” as used herein refers to a structure containing at least the following the elements: silicon and oxygen. Silica may have the fundamental formula of SiO₂ or it may have another structure including SiₓO_{y} (where x and y can each independently be about 1 to 10). Additional elements including, but not limited to, carbon, nitrogen, sulfur, phosphorus, or ruthenium may also be used. Silica may be a solid particle or it may have pores.

In some embodiments, the hydrophobic metal oxide nanoparticles comprise chemically modified metal oxide, wherein the metal oxide comprises nanoclay, SiO₂, TiO₂, Al₂O₃, Fe₂O₃, ZnO, and ZrO or any combination thereof.

In some embodiments, the hydrophobic metal oxide nanoparticles comprise metal oxide chemically modified by any of (C1-C20) alkyl, phenyl, thiol group, vinyl, (C1-C20) fluoroalkyl, (C1-C20) haloalkyl, halogen, epoxy, a cycloalkane, an (C1-C20)alkene, a (C1-C20) haloalkene, an (C1-C20) alkyne, an ether, a silyl group, a siloxane group, and a thioether or any combination thereof. In some embodiments, the hydrophobic metal oxide nanoparticle comprises a silylated silica. In some embodiments, the hydrophobic metal oxide nanoparticle comprises C1-C4 alkyl-silylated silica.

In some embodiments, the hydrophobic metal oxide nanoparticle of the invention is or comprises C1 alkyl-silylated silica (e.g. methyl-silylated silica or dimethyl-silylated silica such as Aerosil 972). In some embodiments, the hydrophobic metal oxide nanoparticle of the invention is or comprises halo-silylated silica (such as fluorinated silica, e.g. silica particles modified with a fluorosilane or with fluoroalkyl silane). Various fluorinated and/or alkylated (e.g. methylated) silica nanoparticles are well-known in the art.

In some embodiments, the hydrophobic metal oxide nanoparticles are characterized by a median particle size of 1 nm to 900 nm. In some embodiments, the hydrophobic metal oxide nanoparticles are characterized by a median particle size of 2 nm to 600 nm, 2 nm to 550 nm, 2 nm to 520 nm, 2 nm to 500 nm, 2 nm to 480 nm, 2 nm to 450 nm, 2 nm to 400 nm, 2 nm to 350 nm, 2 nm to 300 nm, 2 nm to 250 nm, 2 nm to 200 nm, 2 nm to 150 nm, 2 nm to 100 nm, 5 nm to 600 nm, 10 nm to 600 nm, 15 nm to 600 nm, 20 nm to 600 nm, 40 nm to 600 nm, 50 nm to 600 nm, 100 nm to 600 nm, 5 nm to 500 nm, 10 nm to 500 nm, 15 nm to 500 nm, 20 nm to 500 nm, 40 nm to 600 nm, 50 nm to 500 nm, 100 nm to 500 nm, 5 nm to 400 nm, 10 nm to 400 nm, 15 nm to 400 nm, 20 nm to 400 nm, 40 nm to 400 nm, 50 nm to 400 nm, 100 nm to 400 nm, 5 nm to 50 nm, 5 nm to 40 nm, 2 nm to 50 nm, or 2 nm to 40 nm, including any range therebetween. In some embodiments, the size of at least 90% of the hydrophobic metal oxide nanoparticles varies within a range of less than ±25%, ±20%, ±15%, ±19%, ±5%, including any value therebetween.

Herein throughout, the terms “nanoparticle”, “nano”, “nanosized”, and any grammatical derivative thereof, which are used herein interchangeably, describe a particle featuring a size of at least one dimension thereof (e.g., diameter, length) that ranges from about 1 nanometer to 100 nanometers. Herein throughout, “NP(s)” designates nanoparticle(s).

As used herein the terms “average” or “median” size refer to diameter of the particles. The term “diameter” is art-recognized and is used herein to refer to either of the physical diameter (also termed “dry diameter”) or the hydrodynamic diameter. As used herein, the “hydrodynamic diameter” refers to a size determination for the composition in solution (e.g., aqueous solution) using any technique known in the art, e.g., dynamic light scattering (DLS).

In some embodiments, the composition of the invention comprises an oil as the major phase. As used herein, the term “oil” refers to any suitable water-immiscible compound. In some embodiments, the oil is an oil that is liquid at room temperature (20° C.; 1013 mbar). In embodiments, the oil is selected from the group consisting of essential oils, vegetable oils, mineral oils, organic oils, lipids, and any water-immiscible liquids.

In some embodiments, the oil comprises mineral oil, hydrocarbon, fatty acid, mono-, di-, triacylglycerols, vegetable oil, wax, essential oil, aromatic oil, or any combination thereof.

In some embodiments, the oil comprises a mineral oil, a hydrocarbon (e.g. C10-100 hydrocarbon) a fatty acid, a mono-, di-, triacylglycerols, a vegetable oil, a plant oil, a wax or any combination thereof.

In some embodiments, the plant oil is selected from the group consisting of: an olive oil, a canola oil, a triglyceride oil, a terpenoid oil, a citrus oil, a sunflower oil, a peanut oil, a soy oil, a rapeseed oil, a soybean oil, a palm oil, a cocoa butter, a rice bran oil, and limonene or any combination thereof.

In some embodiments, the major phase of the invention comprises a mineral oil and/or a plant oil (e.g. canola oil, sunflower oil, etc.).

### Emulsion

In some embodiments, the composition of the invention is or comprises a Pickering emulsion (e.g. O/O Pickering emulsion), comprising the major phase and a plurality of core-shell particles (or droplets) encapsulating the minor phase. In some embodiments, the minor phase comprises an active agent. In some embodiments, the emulsion comprises an active agent dissolved in the minor phase. In some embodiments, the core of the particles encapsulates an active agent.

In some embodiments, the major phase of the invention is a continuous phase. In some embodiments, the minor phase of the invention is a dispersed phase. In some embodiments, the hydrophobic metal oxide nanoparticle of the invention are in the interface between the major phase and a minor phase.

In some embodiments, the major phase is an oil phase. In some embodiments, the minor phase comprises an oil-immiscible and/or polar solvent.

In some embodiments, the major phase is a water phase. In some embodiments, the minor phase is a water phase.

In some embodiments, the ratio of the major phase and the minor phase is 5:1 to 1:1 (w/w), 4:1 to 1:1 (w/w), 3:1 to 1:1 (w/w), or 2:1 to 1:1 (w/w), including any range therebetween. In some embodiments, the ratio of the major phase and the minor phase is about 1:1 (w/w).

In some embodiments, the composition (e.g. an emulsion) of the invention comprises 0.01% to 10% (w/w), 0.05% to 10% (w/w), 0.09% to 10% (w/w), 0.1% to 10% (w/w), 0.5% to 10% (w/w), 0.9% to 10% (w/w), 1% to 10% (w/w), 10% to 15% (w/w), 15% to 20% (w/w), 5% to 10% (w/w), 0.01% to 9% (w/w), 0.05% to 9% (w/w), 0.09% to 9% (w/w), 0.1% to 9% (w/w), 0.5% to 9% (w/w), 0.9% to 9% (w/w), 1% to 3% (w/w), 3% to 5% (w/w), 5% to 9% (w/w), 5% to 7% (w/w), 7% to 10% (w/w), 1% to 9% (w/w), 5% to 9% (w/w), 0.01% to 5% (w/w), 0.05% to 5% (w/w), 0.09% to 5% (w/w), 0.1% to 5% (w/w), 0.5% to 5% (w/w), 0.9% to 5% (w/w), or 1% to 5% (w/w), of the core-shell particles of the invention, including any range therebetween.

In some embodiments, the core-shell particles are stably dispersed within the emulsion. In some embodiments, the emulsion is stable (e.g. devoid of aggregation, phase separation, release of the core content or any combination thereof) for a time period of at least 1 day, at least 1 week, at least 1 month, at least 1 year, including any range between upon storage at normal storage conditions, as described hereinabove. In some embodiments, a stable emulsion is characterized by substantially constant (e.g. deviation of less than 30%) particle size over a time period ranging from 1 day to 1 month (m), from 1 m to 2 m, from 2 m to 4 m, from 4 m to 6 m, from 6 m to 8 m, from 8 m to 10 m, from 10 m to 12 m, including any range between. In some embodiments, a stable emulsion is characterized by substantially constant content (e.g. reduction of less than 30%, less than 20%, less than 10%, less than 5% by weight including any range between) of the encapsulated active agent within the particle of the invention.

In some embodiments, the emulsion of the invention stably encapsulates the active agent within the core of the particle of the invention, wherein stably encapsulates refers to the ability of the emulsion to maintain the weight content of the active agent within the particle by at least 80%, at least 90%, at least 95%, at least 99%, including any range between, over a time period as described herein.

In some embodiments, the ratio of the nanoparticles to the viscoelastic polymer within the composition of the invention is form 1:0.01 to 1:10 (w/w), 1:0.05 to 1:10 (w/w), 1:0.09 to 1:10 (w/w), 1:0.1 to 1:10 (w/w), 1:0.5 to 1:10 (w/w), 1:0.9 to 1:10 (w/w), 1:1 to 1:10 (w/w), 1:2 to 1:10 (w/w), 1:5 to 1:10 (w/w), 1:7 to 1:10 (w/w), 1:0.01 to 1:5 (w/w), 1:0.05 to 1:5 (w/w), 1:0.09 to 1:5 (w/w), 1:0.1 to 1:5 (w/w), 1:0.5 to 1:5 (w/w), 1:0.9 to 1:5 (w/w), 1:1 to 1:5 (w/w), or 1:2 to 1:5 (w/w), including any range therebetween.

In some embodiments, a w/w ratio of the hydrophobic metal oxide nanoparticles to the viscoelastic polymer within the particle and/or within the composition of the invention is from 1:5 to 5:1, 1:5 to 1:1, 1:5 to 2:5, 2:5 to 4:5, 4:5 to 1:1, 5:1 to 1:1, 5:1 to 1:1, 4:1 to 1:1, 3:1 to 1:1, 2:1 to 1:1, including any range therebetween.

In some embodiments, a w/w ratio of the viscoelastic polymer to the active agent within the particle and/or within the composition of the invention is between 1:0.01 and 1:0.1, between 1:0.01 and 1:0.05, between 1:0.05 and 1:0.07, between 1:0.07 and 1:0.1, between 1:0.1 and 1:0.3, between 1:0.3 and 1:0.5, between 1:0.5 and 1:1, between 1:1 and 1:5, between 1:5 and 1:10, including any range therebetween.

In some embodiments, the core of the particles encapsulates 1% to 20% (w/w) of an active agent. In some embodiments, the composition comprises 5% to 20% (w/w), 10% to 20% (w/w), 1% to 20% (w/w), 5% to 15% (w/w), 10% to 15% (w/w), 15% to 20% (w/w), 1% to 10% (w/w), 5% to 10% (w/w), or 1% to 5% (w/w), of an active agent, including any range therebetween.

In some embodiments, the ratio of the nanoparticles (e.g. hydrophobic metal oxide nanoparticle)s to the active agent within the particle and/or within the composition of the invention is 1:0.01 to 1:10 (w/w), 1:0.05 to 1:10 (w/w), 1:0.09 to 1:10 (w/w), 1:0.1 to 1:10 (w/w), 1:0.5 to 1:10 (w/w), 1:0.9 to 1:10 (w/w), 1:1 to 1:10 (w/w), 1:2 to 1:10 (w/w), 1:5 to 1:10 (w/w), 1:7 to 1:10 (w/w), 1:0.01 to 1:5 (w/w), 1:0.05 to 1:5 (w/w), 1:0.09 to 1:5 (w/w), 1:0.1 to 1:5 (w/w), 1:0.5 to 1:5 (w/w), 1:0.9 to 1:5 (w/w), 1:1 to 1:5 (w/w), or 1:2 to 1:5 (w/w), including any range therebetween.

In some embodiments, a w/w concentration of the viscoelastic polymer of the invention within the composition described herein is between 0.001 and 50%, between 0.001 and 0.01%, between 0.01 and 0.1%, between 0.1 and 0.5%, between 0.5 and 1%, between 1 and 3%, between 3 and 5%, between 5 and 50%, between 6 and 50%, between 5 and 15%, between 15 and 16%, between 16 and 50%, between 20 and 30%, between 30 and 35%, between 35 and 40%, between 40 and 50%, between 15 and 20%, between 15 and 30%, including any range therebetween.

In some embodiments, a w/w concentration of the hydrophobic metal oxide nanoparticles of the invention within the composition described herein is between 0.001 and 15%, between 0.001 and 0.01%, between 0.01 and 0.1%, between 0.1 and 0.5%, between 0.5 and 1%, between 1 and 3%, between 3 and 5%, between 5 and 15%, including any range therebetween.

In some embodiments, a w/w concentration of the active agent of the invention within the composition described herein is between 0.001 and 5%, between 0.001 and 0.01%, between 0.01 and 0.1%, between 0.1 and 0.5%, between 0.5 and 1%, between 1 and 3%, between 3 and 5%, between 5 and 10%, between 10 and 20%, between 20 and 50%, between 50 and 90%, including any range therebetween.

In some embodiments, at least 80%, at least 85%, at least 90%, at least 92%, at least 95%, at least 97%, at least 99%, including any range between of the composition of the invention is composed of: (i) the hydrophobic metal oxide nanoparticles of the invention; (ii) the viscoelastic polymer of the invention; (iii) the major phase and the minor phase described herein, and optionally (iv) of the active agent.

In some embodiments, at least 80%, at least 85%, at least 90%, at least 92%, at least 95%, at least 97%, at least 99%, including any range between of the core-shell particle of the invention is composed of: (i) the hydrophobic metal oxide nanoparticles of the invention; (ii) the viscoelastic polymer of the invention; (iii) the minor phase described herein, and optionally (iv) of the active agent.

In some embodiments, at least 80%, at least 85%, at least 90%, at least 92%, at least 95%, at least 97%, at least 99%, including any range between by dry weight of the core-shell particle or of the composition of the invention is composed of: (i) the hydrophobic metal oxide nanoparticles of the invention; (ii) the viscoelastic polymer of the invention; and optionally (iii) of the active agent.

In some embodiments, the composition of the invention is formulated for application on a substrate by spraying. In some embodiments, the composition of the invention is a sprayable composition (e.g. emulsion). In some embodiments, the composition of the invention is formulated for application on a substrate by any one of: spray coating, rod coating and dip coating, or any combination thereof.

In some embodiments, the composition of the invention is configured for adherence or binding to the substrate, wherein the substrate is as described herein. In some embodiments, the composition of the invention has adhesiveness or affinity to the substrate. In some embodiments, the composition of the invention is capable of stably binding or adhering to the substrate.

In some embodiments, the composition of the invention results in a stable coating on top of the substrate upon application and subsequent drying of the composition on the substrate. In some embodiments, the composition of the invention is characterized by a substantial surface coverage of the substrate, wherein substantial is a s described herein. In some embodiments, the composition of the invention forms a stable film on top of the substrate. In some embodiments, the film remains substantially intact (e.g. retains at least 80%, at least 90%, at least 95% of: its shape, width dimension and/or height dimension, physical properties, and/or surface coverage, etc.) for a time period sufficient for processing (e.g. applying the coating on top the substrate and subsequent drying). In some embodiments, the film remains substantially intact for a time period ranging from 1 minute(m) to 3 days(d), from 1 m to 30 m, from 30 m to 60 m, from 1 hour(h) to 3 h, from 3 to 5 h, from 5 to 20 h, from 10 to 24 h, form 1 d to 2 d, from 2 d to 3 d, including any range or value therebetween. In some embodiments, the film remains substantially intact for a time period described herein, wherein the film is exposed to operable conditions (such as temperature, pressure, etc., sufficient for application of the film and for the subsequent drying thereof).

In some embodiments, the composition of the invention comprises an agricultural composition. In some embodiments, the composition of the invention comprises a pesticidal composition, a herbicidal composition, a fungicidal composition, an anti-mold composition, a plant protective composition, or any combination thereof.

In some embodiments, the composition is for use as: an anti-fungal coating, an anti-microbial coating, an anti-insect coating, an anti-viral coating, an anti-mold coating, a plant protective coating, or a pesticide coating.

### The Article

According to some embodiments, the present invention provides an article comprising (i) a substrate, and (ii) a plurality of dry particles in contact therewith. In some embodiments, the plurality of dry particles are bound to the substrate. In some embodiments, the plurality of dry particles comprise a core and a shell and have a deflated structure. In some embodiments, the plurality of dry particles are in a form of a coating layer on the substrate. In some embodiments, the coating layer further comprises between 0.1 and 50%, between 0.1 and 1%, between 1 and 10%, between 10 and 20%, between 20 and 30%, between 30 and 50% by weight of the oil or major phase of the invention in contact with the plurality of dry particles, including any range between.

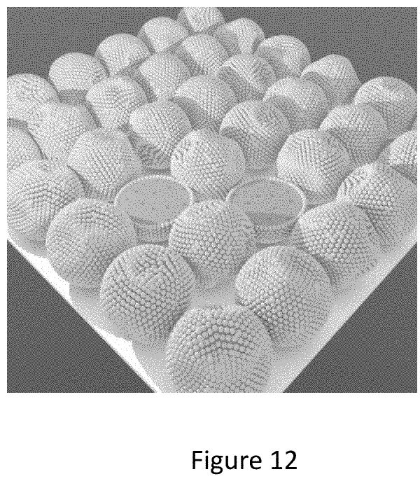

In some embodiments, the plurality of dry particles are in a form of an array on top of the substrate (see FIG. 12). In some embodiments, the plurality of dry particles are in a form of an array on top of the substrate, wherein the plurality of dry particles are arranged within a pattern. In some embodiments, a center-to center distance between the dry particles within the array is between 0.1 and 10 um, between 0.1 and 1 um, between 1 and 2 um, between 2 and 3 um, between 0.1 and 0.5 um, between 3 and Sum, between 5 and 10 um, including any range between.

In some embodiments, the plurality of dry particles are stably bound and/or adhered to the substrate. In some embodiments, the plurality of dry particles are stably bound and/or adhered to the substrate, wherein bound and/or adhered is via a physical bond and/or via a non-covalent bond.

In some embodiments, the plurality of dry particles are stably bound and/or adhered to a fiber of the substrate. In some embodiments, the plurality of dry particles are stably bound and/or adhered to a plurality of fibers of the substrate. In some embodiments, the plurality of dry particles are stably bound and/or adhered to a plurality of fibers on or within the substrate.

In some embodiments, the plurality of dry particles are core-shell particles. In some embodiments, each of the plurality of dry particles, comprises a shell and a core, wherein: the core comprises (i) 1% to 90% (w/w) of a viscoelastic polymer, and optionally (ii) 0.1% to 50% (w/w) of an active agent; and wherein the shell comprises a plurality of hydrophobic metal oxide nanoparticles in contact with the viscoelastic polymer. In some embodiments, a w/w concentration of the viscoelastic polymer within the shell is between 5 to 50%.

In some embodiments, the viscoelastic polymer, the hydrophobic metal oxide nanoparticles, and the active agent are as described hereinabove. In some embodiments, the term “viscoelastic polymer” and the term “polymer” are used herein interchangeably. In some embodiments, the term “hydrophobic inorganic nanoparticle” and the term “hydrophobic metal oxide nanoparticle” are used herein interchangeably.

In some embodiments, the viscoelastic polymer and the active agent comprise up to 80%, up to 85%, up to 90%, up to 92%, up to 95%, up to 97%, up to 99%, up to 98%, up to 96% w/w of the dry particle's core. In some embodiments, the viscoelastic polymer and the active agent comprise between 80 and 99.9% w/w of the dry particle's core. In some embodiments, the viscoelastic polymer and the hydrophobic metal oxide nanoparticles comprise up to 80%, up to 85%, up to 90%, up to 92%, up to 95%, up to 97%, up to 99%, up to 98%, up to 96% w/w of the dry particle's shell. In some embodiments, the viscoelastic polymer and the hydrophobic metal oxide nanoparticles comprise between 80 and 99.9% w/w of the dry particle's shell.

In some embodiments, the dry particle has a spherical geometry or shape. In some embodiments, the dry particle has an inflated or a deflated shape. In some embodiments, a plurality of dry particles is devoid of any characteristic geometry or shape. In some embodiments, the plurality of dry particles are substantially spherically shaped. In some embodiments, the dry particle is in a form of a hollow sphere.

In some embodiments, a volume of the core of the dry particle comprises at most 95%, at most 90%, at most 85%, at most 80%, at most 75%, at most 70%, at most 60%, at most 50%, at most 40%, at most 30%, at most 20% v/v of a non-gaseous material (such as the viscoelastic polymer and the active agent).

In some embodiments, the dry particle is a core-shell particle. In some embodiments, the shell comprises an inner portion facing the core and an outer portion facing an ambient.

In some embodiments, the inner portion is in contact with the core. In some embodiments, the inner portion is bound to the core. In some embodiments, the shell stabilizes the core. In some embodiments, the shell encapsulates the core.

In some embodiments, the shell of the dry particle has a thickness between 10 nm and 100 um, between 10 and 100 nm, between 100 and 500 nm, between 500 nm and 1 μm, between 1 and 10 μm, between 10 and 20 μm, between 20 and 50 μm, between 50 and 70 μm, between 70 and 90 μm, between 90 and 100 μm, including any range therebetween.

In some embodiments, the shell of the dry particle comprises between 10% and 99%, between 10% and 20%, between 20% and 30%, between 30% and 50%, between 50% and 60%, between 60% and 70%, between 70% and 80%, between 80% and 90%, between 90% and 99%, (w/w) of the hydrophobic metal oxide nanoparticles.

In some embodiments, the dry particle comprises between 1% and 90%, between 10% and 99%, between 10% and 20%, between 20% and 30%, between 30% and 50%, between 50% and 60%, between 60% and 70%, between 70% and 80%, between 80% and 90%, between 90% and 99% (w/w) of the hydrophobic metal oxide nanoparticles.

In some embodiments, the shell of the dry particle is stabilized by the polymer. In some embodiments, the polymer is a viscoelastic polymer. In some embodiments, the shell of the dry particle comprises the viscoelastic polymer bound to the hydrophobic metal oxide nanoparticles. In some embodiments, the hydrophobic metal oxide nanoparticles are adhered to the viscoelastic polymer. In some embodiments, the hydrophobic metal oxide nanoparticles are held together by the viscoelastic polymer. In some embodiments, a portion of the viscoelastic polymer enhances the stability of the shell of the dry particle.

In some embodiments, the inner portion of the shell is bound or in contact with the polymeric portion of the core of the dry particle. In some embodiments, the shell is bound or in contact with the polymeric portion of the core. In some embodiments, the inner portion of the shell, the outer portion of the shell or both comprise the viscoelastic polymer.

In some embodiments, the w/w concentration of the viscoelastic polymer within the shell of the dry particle is between 5 to 50%, between 5 to 10%, between 10 to 20%, between 20 to 30%, between 30 to 40%, between 40 to 50%, including any range therebetween.

In some embodiments, the core of the dry particle comprises between 1% and 90%, between 1% and 10%, between 1% and 5%, between 5% and 10%, between 10% and 20%, between 20% and 30%, between 30% and 40%, between 40% and 50%, between 50% and 70%, between 70% and 90% (w/w) of the viscoelastic polymer, including any range therebetween.

In some embodiments, the core of the dry particle comprises a plurality of layers. In some embodiments, the core comprises an outer layer facing the shell. In some embodiments, the core outer layer comprises the viscoelastic polymer. In some embodiments, between 50% and 99.9% w/w of the core outer layer comprises the viscoelastic polymer. In some embodiments, between 10% and 99.9% w/w of the core inner layer comprises the active agent.

In some embodiments, the core outer layer of the dry particle stabilizes the active agent. In some embodiments, the core outer layer of the dry particle encapsulates the active agent, and the shell stabilizes the core outer layer.

In some embodiments, the viscoelastic polymer is in a form of an interconnected network within the dry particle. In some embodiments, the viscoelastic polymer is in a form of an interconnected network within the dry particle core. In some embodiments, the viscoelastic polymer has an amorphous structure within the dry particle. In some embodiments, the viscoelastic polymer has an amorphous structure within the dry particle shell.

In some embodiments, the core of the dry particle comprises a network-structured polymer encapsulating the active agent within the network. In some embodiments, the core of the dry particle comprises a network-structured polymer encapsulating the active agent, wherein the active agent is a liquid. In some embodiments, the active agent is in a form of droplets. In some embodiments, the active agent is dispersed or uniformly distributed within the polymeric matrix of the dry particle. In some embodiments, the active agent is dispersed within the core of the dry particle.

In some embodiments, the shell of the dry core-shell particle further comprises hydrophobic metal oxide nanoparticles in contact with the viscoelastic polymer. In some embodiments, a w/w concentration of the viscoelastic polymer within the shell of the dry particle is between 5 to 50% w/w, between 1 and 10%, between 10 and 50% including nay range between.

In some embodiments, the dry particle has a spherical geometry or shape. In some embodiments, the dry particle has an inflated or a deflated shape. In some embodiments, a plurality of dry particles is devoid of any characteristic geometry or shape. In some embodiments, the plurality of dry particles are substantially spherically shaped.

In some embodiments, the dry particle is in a form of a hollow sphere. In some embodiments, a volume of the core comprises at most 95%, at most 90%, at most 85%, at most 80%, at most 75%, at most 70%, at most 60%, at most 50%, at most 40%, at most 30%, at most 20% v/v of a non-gaseous material (such as the viscoelastic polymer and the active agent).

In some embodiments, the dry particle has a diameter between 0.5 μm and 500 μm, 1 μm to 100 μm, 5 μm to 100 μm, 10 μm to 100 μm, 50 μm to 100 μm, 1 μm to 80 μm, 10 μm to 80 μm, 50 μm to 80 μm, 10 μm to 50 μm, 80 μm to 100 μm, 100 μm to 200 μm, 200 μm to 300 μm, 300 μm to 400 μm, 400 μm to 500 μm, 1 μm to 10 μm, 5 μm to 10 μm, 1 μm to 50 μm, 10 μm to 50 μm, 5 μm to 50 μm, or 1 μm to 5 μm, including any range or value therebetween.

In some embodiments, the diameter of the dry particle described herein, represents an average diameter. In some embodiments, the size of the dry particle described herein represents an average or median size of a plurality of particles. In some embodiments, the average or the median size of at least e.g., 10%, 20%, 30%, 40%, 50%, 60%, 70%, 80%, 90%, or 95% of the particles, ranges from: 5 μm to 50 μm, 1 μm to 50 μm, 5 μm to 10 μm, including any range therebetween. In some embodiments, the diameter of the particle described herein, is a dry diameter (i.e. a diameter of isolated dried particles). In some embodiments, a plurality of the particles has a uniform size. By “uniform” or “homogenous” it is meant to refer to size distribution that varies within a range of less than e.g., ±60%, ±50%, ±40%, ±30%, ±20%, or ±10%, including any value therebetween.

In some embodiments, the dry particle is in a form of a colloidosome. In some embodiments, the dry particle is substantially solid. In some embodiments, the dry particle is in a solid form (e.g. an amorphous solid).

In some embodiments, a w/w ratio of the plurality of nanoparticles (such as hydrophobic metal oxide nanoparticles) to the viscoelastic polymer within the dry particle is 1:5 to 5:1, 1:5 to 1:1, 1:5 to 2:5, 2:5 to 4:5, 4:5 to 1:1, 5:1 to 1:1, 5:1 to 1:1, 4:1 to 1:1, 3:1 to 1:1, 2:1 to 1:1, including any range therebetween.

In some embodiments, a w/w ratio of the viscoelastic polymer to the active agent within the dry particle is 1:0.01 to 1:0.1.

In some embodiments, the dry diameter of the particles, as prepared according to some embodiments of the invention, may be evaluated using transmission electron microscopy (TEM) or scanning electron microscopy (SEM) imaging.

The dry particle(s) can be generally shaped as a sphere, incomplete-sphere, particularly the size attached to the substrate, a rod, a cylinder, a ribbon, a sponge, and any other shape, or can be in a form of a cluster of any of these shapes, or a mixture of one or more shapes. In some embodiments, the dry particle has a spherical shape, a quasi-spherical shape, a quasi-elliptical sphere, an irregular shape, or any combination thereof.

In some embodiments, the core of the dry particles encapsulates 1% to 40% (w/w) of a viscoelastic polymer. In some embodiments, the dry particle comprises 5% to 40% (w/w), 10% to 40% (w/w), 25% to 40% (w/w), 1% to 30% (w/w), 5% to 30% (w/w), 10% to 30% (w/w), 25% to 30% (w/w), 1% to 10% (w/w), 5% to 10% (w/w), or 1% to 5% (w/w), of a viscoelastic polymer, including any range therebetween.

In some embodiments, the ratio of the nanoparticles to the viscoelastic polymer within the dry particle is from 1:0.01 to 1:10 (w/w), 1:0.05 to 1:10 (w/w), 1:0.09 to 1:10 (w/w), 1:0.1 to 1:10 (w/w), 1:0.5 to 1:10 (w/w), 1:0.9 to 1:10 (w/w), 1:1 to 1:10 (w/w), 1:2 to 1:10 (w/w), 1:5 to 1:10 (w/w), 1:7 to 1:10 (w/w), 1:0.01 to 1:5 (w/w), 1:0.05 to 1:5 (w/w), 1:0.09 to 1:5 (w/w), 1:0.1 to 1:5 (w/w), 1:0.5 to 1:5 (w/w), 1:0.9 to 1:5 (w/w), 1:1 to 1:5 (w/w), or 1:2 to 1:5 (w/w), including any range therebetween.

In some embodiments, the core of the dry particles encapsulates 1% to 20% (w/w) of an active agent. In some embodiments, the dry particle comprises 0.5% to 20% (w/w), 10% to 20% (w/w), 0.5 to 1% w/w, 1% to 20% (w/w), 5% to 15% (w/w), 10% to 15% (w/w), 15% to 20% (w/w), 1% to 10% (w/w), 5% to 10% (w/w), or 1% to 5% (w/w), of an active agent, including any range therebetween.

In some embodiments, the ratio of the nanoparticles (e.g. hydrophobic metal oxide nanoparticle)s to the active agent within the dry particle is 1:0.01 to 1:10 (w/w), 1:0.05 to 1:10 (w/w), 1:0.09 to 1:10 (w/w), 1:0.1 to 1:10 (w/w), 1:0.5 to 1:10 (w/w), 1:0.9 to 1:10 (w/w), 1:1 to 1:10 (w/w), 1:2 to 1:10 (w/w), 1:5 to 1:10 (w/w), 1:7 to 1:10 (w/w), 1:0.01 to 1:5 (w/w), 1:0.05 to 1:5 (w/w), 1:0.09 to 1:5 (w/w), 1:0.1 to 1:5 (w/w), 1:0.5 to 1:5 (w/w), 1:0.9 to 1:5 (w/w), 1:1 to 1:5 (w/w), or 1:2 to 1:5 (w/w), including any range therebetween.

In some embodiments, the core of the dry particles is void. In some embodiments, the core of the dry particles is substantially devoid of a fluid (e.g. minor phase). In some embodiments, the core of the dry particles is devoid of the active agent. In some embodiments, a composition comprising a plurality of dry particles with a void core (e.g. a coating layer) has a liquid content of at most 10%, at most 5%, at most 3%, at most 1%, at most 0.5%, at most 0.1%, including any range between, wherein liquid comprises an aqueous solvent, an organic solvent and/or a ketone solvent described herein.

In some embodiments, the dry particles and/or the coating comprising thereof stably encapsulate an agriculturally effective amount of the active agent. In some embodiments, the dry particles and/or the coating comprising thereof stably encapsulate a pesticidal effective amount of the active agent.

In some embodiments, the dry particles and/or the coating comprising thereof stably encapsulate the active agent over a time period ranging from 1 day to 1 month (m), from 1 m to 2 m, from 2 m to 4 m, from 4 m to 6 m, from 6 m to 8 m, from 8 m to 10 m, from 10 m to 12 m, including any range between.

In some embodiments, the dry particles and/or the coating comprising thereof stably encapsulate the active agent, wherein stably refers to the ability of the dry particles and/or the coating to maintain the weight content of the active agent within the particle by at least 10%, at least 20%, at least 30%, at least 40%, at least 50%, at least 60%, at least 70%, including any range between, over a time period as described herein.

In some embodiments, the dry particles and/or the coating comprising thereof are capable of releasing the active agent therefrom. In some embodiments, the dry particles and/or the coating comprising thereof are characterized by a gradual release profile of the active agent. In some embodiments, the dry particles and/or the coating comprising thereof are capable of releasing an effective amount of the active agent. In some embodiments, the dry particles and/or the coating comprising thereof are capable of releasing an agriculturally effective amount of the active agent. In some embodiments, the dry particles and/or the coating comprising thereof are capable of releasing a pesticidal effective amount of the active agent.

In some embodiments, effective amount of the active agent is sufficient for reducing or inhibiting pest load within the area under cultivation. In some embodiments, effective amount of the active agent is sufficient for reducing or inhibiting pest load on top of the substrate. In some embodiments, pest (or pathogen) is as described herein.

In some embodiments, the dry particles and/or the coating comprising thereof are capable of releasing an effective amount of the active agent over a time period ranging between 1 and 5 days(d), between 5 and 10 d, between 1 and 5 w, between 5 and 10 w, between 10 and 15 w, between 15 and 20 w, between 1 and 3 months (m), between 3 and 5 m, between 5 and 10 m, including any range between. In some embodiments, the release of the active agent form the dry particles and/or the coating comprising thereof is triggered by exposure to the ambient conditions, e.g. ambient pressure, air atmosphere, temperature of between 0 and 50° C., and/or moisture. It should be appreciated, that the release of the active agent can be preventing by storing the article of the invention under gas pressure, thereby substantially preventing pre-mature release of the active agent.

In some embodiments, the dry particles and/or the coating comprising thereof are capable of releasing an effective amount of the active agent over a time period as escribed herein, wherein the effective amount comprises between 10 and 99%, between 10 and 20%, between 20 and 30%, between 30 and 40%, between 40 and 50%, between 50 and 70%, between 70 and 90%, between 90 and 99% by weight of the initial concentration of the active agent. The term “initial concentration” relates to the concentration of the active agent within the coating immediately after the formation of the coating layer.

According to some embodiments, the present invention provides an article comprising the emulsion of the present invention. In some embodiments, the article comprises the emulsion and a substrate, wherein the emulsion is in the form of a coating layer on the substrate. In some embodiments, the emulsion is in the form of a coating layer in at least a portion of a surface of the substrate. In some embodiments, the emulsion is evaporated resulting in an oil, and a plurality of particles comprising a core and a shell and having a deflated structure, wherein the oil is adsorbed on the surface of the particles and the plurality of particles are in the form of a coating layer on the substrate.

In some embodiments, the substrate is selected from, a polymeric substrate, glass substrate, a metallic substrate, a paper substrate, a carton substrate, a polystyrene substrate, a tissue-based substrate, a brick wall, a sponge, a textile, a non-woven fabric, or wood.

In some embodiments, the substrate is a polymeric substrate comprising a polyolefin.

In some embodiments, the substrate is a woven polymeric substrate. In some embodiments, the substrate is a non-woven polymeric substrate. In some embodiments, the substrate is selected from a polyethylene substrate or a polypropylene substrate. In some embodiments, the substrate is non-woven polypropylene.

In some embodiments, the coating adheres to the substrate.

In some embodiments, the coating layer is characterized by an average thickness of 10 nm to 400 μm, 25 nm to 400 μm, 50 nm to 400 μm, 100 nm to 400 μm, 250 nm to 400 μm, 500 nm to 400 μm, 900 nm to 400 μm, 1 μm to 400 μm, 10 μm to 400 μm, 50 μm to 400 μm, 100 μm to 400 μm, 250 μm to 400 μm, 10 nm to 100 μm, 25 nm to 100 μm, 50 nm to 100 μm, 100 nm to 100 μm, 250 nm to 100 μm, 500 nm to 100 μm, 900 nm to 100 μm, 1 μm to 100 μm, 10 μm to 100 μm, 50 μm to 100 μm, 10 nm to 10 μm, 25 nm to 10 μm, 50 nm to 10 μm, 100 nm to 10 μm, 250 nm to 10 μm, 500 nm to 10 μm, 900 nm to 10 μm, or 1 μm to 10 μm, including any range therebetween.

In some embodiments, the coating layer is characterized by a water contact angle (WCA) in the range of 120° to 180°, 130° to 180°, 120° to 168°, 130° to 165°, 130° to 160°, 130° to 150°, or 135° to 165°, including any range therebetween.

In some embodiments, the article is characterized by a water contact angle of at least 120°. In some embodiments, the article is characterized by a water contact angle in the range of 100° to 180°, 110° to 180°, 120° to 180°, 130° to 180°, 130° to 168°, 130° to 165°, 130° to 160°, 130° to 150°, or 135° to 165°, including any range therebetween.

In some embodiments, the article is characterized by a surface contact angle of more than 100°. In some embodiments, the coating layer is characterized by a surface contact angle of more than 105°, 110°, 115°, 120°, 125°, 130°, including any value therebetween.

In some embodiments, the coating layer is characterized by a roll-off (RA) angle of less than 30°, less than 25°, less than 20°, less than 15°, less than 10°, less than 9°, less than 8°, less than 7°, less than 6°, or less than 5°, including any value therebetween. In some embodiments, the coating layer is characterized by a RA angle of 10° to 1°, 10° to 3°, 10° to 5°, 9° to 1°, 9° to 3°, 9° to 5°, 8° to 1°, 8° to 3°, or 8° to 5°, including any range therebetween. In some embodiments, the article is characterized by a RA angle of less than 10°, less than 9°, less than 8°, less than 7°, less than 6°, or less than 5°, including any value therebetween. In some embodiments, the article is characterized by a RA angle of 10° to 1°, 10° to 3°, 10° to 5°, 9° to 1°, 9° to 3°, 9° to 5°, 8° to 1°, 8° to 3°, or 8° to 5°, including any range therebetween.

In some embodiments, the coating layer is stable at a temperature range of −100° C. to 1500° C., −50° C. to 1500° C., −10° C. to 1500° C., 0° C. to 1500° C., 10° C. to 1500° C., 50° C. to 1500° C., 100° C. to 1500° C., 500° C. to 1500° C., −100° C. to 500° C., −50° C. to 500° C., −10° C. to 500° C., 0° C. to 500° C., 10° C. to 100° C., 100° C. to 200° C., 10° C. to 500° C., 50° C. to 500° C., or 100° C. to 500° C., including any range therebetween.

In some embodiments, the coating layer is characterized by a transparency of 30% to 100%, 40% to 100%, 50% to 100%, 60% to 100%, 70% to 100%, 80% to 100%, 30% to 99.9%, 40% to 99.9%, 50% to 99.9%, 60% to 99.9%, 70% to 99.9%, 80% to 99.9%, 30% to 99%, 40% to 99%, 50% to 99%, 60% to 99%, 70% to 99%, 80% to 99%, 30% to 98%, 40% to 98%, 50% to 98%, 60% to 98%, 70% to 98%, 80% to 98%, 30% to 95%, 40% to 95%, 50% to 95%, 60% to 95%, 70% to 95%, 80% to 95%, 30% to 90%, 40% to 90%, 50% to 90%, 60% to 90%, 70% to 90%, or 80% to 90%, including any range therebetween.

In some embodiments, the article is characterized by a transparency of 30% to 100%, 40% to 100%, 50% to 100%, 60% to 100%, 70% to 100%, 80% to 100%, 30% to 99.9%, 40% to 99.9%, 50% to 99.9%, 60% to 99.9%, 70% to 99.9%, 80% to 99.9%, 30% to 99%, 40% to 99%, 50% to 99%, 60% to 99%, 70% to 99%, 80% to 99%, 30% to 98%, 40% to 98%, 50% to 98%, 60% to 98%, 70% to 98%, 80% to 98%, 30% to 95%, 40% to 95%, 50% to 95%, 60% to 95%, 70% to 95%, 80% to 95%, 30% to 90%, 40% to 90%, 50% to 90%, 60% to 90%, 70% to 90%, or 80% to 90%, including any range therebetween.

In some embodiments, the coating layer is characterized by a pattern comprising an array of arranged dry particles of the invention. In some embodiments, the coating layer is characterized by a layered structure comprising microstructures and nanostructures on top of the microstructures.

In some embodiments, the microstructures have a spherical shape, a quasi-spherical shape, a quasi-elliptical sphere, an irregular shape, or any combination thereof.

In some embodiments, the plurality of particles comprising a core and a shell, form microstructures having a deflated structure.

In some embodiments, the diameter of the microstructures is comparable to the diameter of the corresponding particles of the emulsion described herein. In some embodiments, the diameter of the deflated particles is 0.1% to 10%, 0.2% to 10%, 0.3% to 10%, 0.4% to 10%, 0.5% to 10%, 0.1% to 8%, 0.1% to 5%, or 0.1% to 1%, of the diameter of the corresponding particle in the emulsion, including any range therebetween. In some embodiments, the diameter of the deflated particles is 0.5 μm to 15 μm, 0.9 μm to 15 μm, 1 μm to 15 μm, 2 μm to 15 μm, 2.5 μm to 15 μm, 0.5 μm to 10 μm, 0.9 μm to 10 μm, 1 μm to 10 μm, 2 μm to 10 μm, 2.5 μm to 10 μm, including any range therebetween.

In some embodiments, the diameter of spherical microstructures can be compared to the surface area of the quasi-spherical, quasi-elliptical, and irregular shape microstructures.

As used herein, the “particle size” for a spherical particle can be defined by its diameter. With irregular and non-spherical particles, described herein, a volume-based particle size can be approximated by the diameter of a sphere that has the same volume as the non-spherical particle. Similarly, an area-based particle size can be approximated by the diameter of the sphere that has the same surface area as the non-spherical particle.

In some embodiments, the concentration of the polymer in the composition influences the shape of the microstructure obtained in the coating. In some embodiments, the shape of the microstructure can be controlled by controlling the amount of polymer used in the composition. In some embodiments, the shape of the microstructures can be compared to a shell-like shape. In some embodiments, the shape of the microstructures can be compared to a deflated ball-like shape.

In some embodiments, the concentration of the active agent in the composition influences the shape of the microstructure obtained in the coating. In some embodiments, the shape of the microstructure can be controlled by controlling the amount of active agent used in the composition.

In some embodiments, the nanostructures comprise fluorinated and/or methylated silica nanoparticles. In some embodiments, the nanostructures comprise silane hydrophobic silica nanoparticles. In some embodiments, the nanostructures comprise fluorinated silica nanoparticles and/or methyl-silylalted hydrophobic silica nanoparticles.

In some embodiments, the nanostructures comprise 100% fluorinated silica nanoparticles. In some embodiments, the nanostructures comprise about 0.1% fluorinated silica nanoparticles and about 99.9% silane hydrophobic silica nanoparticles. In some embodiments, the nanostructures comprise about 0.5% fluorinated silica nanoparticles and about 99.5% silane hydrophobic silica nanoparticles. In some embodiments, the nanostructures comprise about 0.3% fluorinated silica nanoparticles and about 99.7% silane hydrophobic silica nanoparticles.

In some embodiments, the nanostructures comprise fluorinated silica nanoparticles and tricholoro(octadecyl)silane (OTS). In some embodiments, the nanostructures comprise fluorinated silica nanoparticles and OTS at a ratio of 10:1-1:10.

In some embodiments, the coating layer has at least one characteristic selected from: an anti-fungal coating, an anti-microbial coating, an anti-insect coating, an anti-viral coating, an anti-mold coating, a plant protective coating, and a pesticide coating.

In some embodiments, the composition comprises an adhesiveness property to a surface. In some embodiments, the coating layer comprises an adhesiveness property to a surface.

In some embodiments, at least one characteristic of the coating layer is maintained after abrasion. In some embodiments, the coating layer has abrasion resistance. In some embodiments, the coating layer is physically stable to abrasion. In some embodiments, at least 50%, at least 60%, at least 70%, at least 80%, at least 90% of the coating layer is physically stable to abrasion, wherein physically stable is as described herein.

In some embodiments, the anti-fungal properties of the coating layer are maintained after abrasion. In some embodiments, the anti-fungal properties of the coating layer are maintained after 1, 2, 5, 10, 20, 25, 30, 40, 45, 50, 55, 60, or 65 abrasion cycles. In some embodiments, at least 99%, at least 98%, at least 95%, at least 90%, at least 85%, at least 80%, at least 70%, at least 60%, or at least 50% of the anti-fungal properties of the coating layer are maintained after abrasion.

In some embodiments, the anti-microbial properties of the coating layer is maintained after abrasion. In some embodiments, the anti-microbial properties of the coating layer are maintained after 1, 2, 5, 10, 20, 25, 30, 40, 45, 50, 55, 60, or 65 abrasion cycles. In some embodiments, at least 99%, at least 98%, at least 95%, at least 90%, at least 85%, at least 80%, at least 70%, at least 60%, or at least 50% of the anti-microbial properties of the coating layer is maintained after abrasion.

In some embodiments, the anti-insect properties of the coating layer are maintained after abrasion. In some embodiments, the anti-insect properties of the coating layer are maintained after 1, 2, 5, 10, 20, 25, 30, 40, 45, 50, 55, 60, or 65 abrasion cycles. In some embodiments, at least 99%, at least 98%, at least 95%, at least 90%, at least 85%, at least 80%, at least 70%, at least 60%, or at least 50% of the anti-insect properties of the coating layer are maintained after abrasion.

In some embodiments, the anti-viral properties of the coating layer are maintained after abrasion. In some embodiments, the anti-viral properties of the coating layer are maintained after 1, 2, 5, 10, 20, 25, 30, 40, 45, 50, 55, 60, or 65 abrasion cycles. In some embodiments, at least 99%, at least 98%, at least 95%, at least 90%, at least 85%, at least 80%, at least 70%, at least 60%, or at least 50% of the anti-viral properties of the coating layer are maintained after abrasion.

In some embodiments, the anti-mold properties of the coating layer are maintained after abrasion. In some embodiments, the anti-mold properties of the coating layer are maintained after 1, 2, 5, 10, 20, 25, 30, 40, 45, 50, 55, 60, or 65 abrasion cycles. In some embodiments, at least 99%, at least 98%, at least 95%, at least 90%, at least 85%, at least 80%, at least 70%, at least 60%, or at least 50% of the anti-mold properties of the coating layer are maintained after abrasion.

In some embodiments, the plant protective properties of the coating layer are maintained after abrasion. In some embodiments, the plant protective properties of the coating layer are maintained after 1, 2, 5, 10, 20, 25, 30, 40, 45, 50, 55, 60, or 65 abrasion cycles. In some embodiments, at least 99%, at least 98%, at least 95%, at least 90%, at least 85%, at least 80%, at least 70%, at least 60%, or at least 50% of the plant protective properties of the coating layer are maintained after abrasion.

In some embodiments, the pesticidal properties of the coating layer are maintained after abrasion. In some embodiments, the pesticidal properties of the coating layer are maintained after 1, 2, 5, 10, 20, 25, 30, 40, 45, 50, 55, 60, or 65 abrasion cycles. In some embodiments, at least 99%, at least 98%, at least 95%, at least 90%, at least 85%, at least 80%, at least 70%, at least 60%, or at least 50% of the pesticidal properties of the coating layer are maintained after abrasion.

In some embodiments, the coating layer according to the present invention, is stable (e.g. chemically stable and/or physically stable) to climatic changes. In some embodiments, the coating layer is stable (e.g. chemically stable and/or physically stable) to temperature changes, heat, cold, UV radiation and atmospheric corrosive elements. In some embodiments, the physicochemical properties of the coating layer are not affected or altered by climatic changes as described herein. In some embodiments, the article according to the present invention, is stable (e.g. chemically stable and/or physically stable) to climatic changes. In some embodiments, the article is stable (e.g. chemically stable and/or physically stable) to temperature changes, heat, cold, UV/vis radiation and atmospheric corrosive elements. In some embodiments, the properties of the article are substantially retained, upon exposure climatic changes as described herein.

In some embodiments, the coating layer of the invention is stably adhered to the substrate. In some embodiments, the coating layer of the invention remains stably bound (physically stable) or in contact with the substrate for a time period ranging from 1 day to 1 month (m), from 1 m to 2 m, from 2 m to 4 m, from 4 m to 6 m, from 6 m to 8 m, from 8 m to 10 m, from 10 m to 12 m, from 12 m to 20 m, from 20 m to 30 m, from 30 m to 40 m, from 40 m to 50 m, including any range between. In some embodiments, the coating layer of the invention remains stably bound (physically stable) or in contact with the substrate when exposed to ambient conditions at the area under cultivation (e.g. exposure to UV/vis light, rain, moisture, temperatures of between −20 and 50° C., etc.).

In some embodiments, the coating layer and/or the article comprising thereof is chemically stable (e.g. maintains at least 80%, at least 90%, at least 95% of its chemical structure) at a temperature of 100° C., of 80° C., of 90° C., of 70° C., of 60° C., of 50° C., of 40° C. including any range or value therebetween.

In some embodiments, the coating layer and/or the article comprising thereof is physically stable (e.g. maintains at least 80%, at least 90%, at least 95% of: its physical properties and/or physical intactness; of its height dimension and/or width dimension; of its geometrical shape, etc.) at a temperature of 100° C., of 80° C., of 90° C., of 70° C., of 60° C., of 50° C., of 40° C. including any range or value therebetween.

In some embodiments, the coating layer and/or the article comprising thereof is stable over a time period ranging from 1 day to 1 month (m), from 1 m to 2 m, from 2 m to 4 m, from 4 m to 6 m, from 6 m to 8 m, from 8 m to 10 m, from 10 m to 12 m, from 12 m to 20 m, from 20 m to 30 m, from 30 m to 40 m, from 40 m to 50 m, including any range between, wherein stable is as described herein.

In some embodiments, the coating layer is for use as an anti-fungal coating, an anti-microbial coating, an anti-insect coating, an anti-viral coating, an anti-mold coating, a plant protective coating, and a pesticide coating.

### The Method

According to some embodiments, the present invention provides a method of coating a substrate. In some embodiments, the method comprises the steps of: i) providing a substrate; and ii) contacting the substrate with the composition as described herein, thereby forming a coating layer on the substrate.

In some embodiments, contacting is selected from the group comprising: spin coating, roll coating, spray coating, kiss coating, air knife coating, anilox coater, flexo coater, gap coating, dip coating, rod coating, and dipping.

In some embodiments, the substrates are placed in hot air oven. In some embodiments, the substrates are places in a hot air oven at a temperature ranging from 20° C. to 180° C., 25° C. to 180° C., 30° C. to 180° C., 30° C. to 150° C., 30° C. to 90° C., 30° C. to 80° C., 30° C. to 70° C., 30° C. to 60° C., 40° C. to 180° C., 40° C. to 150° C., 40° C. to 90° C., 40° C. to 80° C., 40° C. to 70° C., 40° C. to 60° C., 50° C. to 180° C., 50° C. to 150° C., 50° C. to 90° C., 50° C. to 80° C., 50° C. to 70° C., or 50° C. to 60° C., including any range therebetween. In some embodiments, the substrates are placed in hot air oven for a period of time in the rage of 1 hour to 24 hour, 2 hour to 24 hour, 3 hour to 24 hour, 5 hour to 24 hour, 6 hour to 24 hour, 1 hour to 12 hour, 2 hour to 12 hour, 3 hour to 12 hour, 5 hour to 12 hour, 6 hour to 12 hour, 1 hour to 8 hour, 2 hour to 8 hour, 3 hour to 8 hour, or 5 hour to 8 hour, including any range therebetween.

In some embodiments, the substrate is selected from the group comprising: a polymeric substrate, a glass substrate, a tissue-based substrate, a metallic substrate, a paper substrate, a carton substrate, a brick wall, a sponge, a textile, a non-woven fabric, a polystyrene substrate, or wood.

In some embodiments, the polymeric substrate is selected from a polyethylene substrate or a polypropylene substrate. In some embodiments, the substrate is non-woven polypropylene.

In some embodiments, the coating adheres to the substrate.

In some embodiments, the coated substrate has at least one characteristic selected from: an anti-fungal coating, an anti-microbial coating, an anti-insect coating, an anti-viral coating, an anti-mold coating, a plant protective coating, a pesticide coating.

According to some embodiments, the present invention provides a method for preparing the composition described herein, comprising the steps of: a. mixing 0.5% to 10% (w/w) of the hydrophobic metal oxide nanoparticles to the major phase, thereby forming a mixture; and b. adding the minor phase to the mixture, and mixing for a period of time.

In some embodiments, mixing is high shear mixing, ultrasonication, overhead stirring, homogenizing, or a combination thereof. In some embodiments, a period of time is 1 min to 24 hour, 5 min to 24 hour, 10 min to 24 hour, 30 min to 24 hour, 1 hour to 24 hour, 2 hour to 24 hour, 3 hour to 24 hour, 5 hour to 24 hour, 6 hour to 24 hour, 1 hour to 12 hour, 2 hour to 12 hour, 3 hour to 12 hour, 5 hour to 12 hour, 6 hour to 12 hour, 1 hour to 8 hour, 2 hour to 8 hour, 3 hour to 8 hour, or 5 hour to 8 hour, including any range therebetween.

In some embodiments, the minor phase comprises 0.5% to 40% (w/w), 0.5% to 30% (w/w), 0.9% to 30% (w/w), 1% to 30% (w/w), 5% to 30% (w/w), 10% to 30% (w/w), 25% to 30% (w/w), 0.5% to 10% (w/w), 0.9% to 10% (w/w), 1% to 10% (w/w), 5% to 10% (w/w), 0.5% to 5% (w/w), 0.9% to 5% (w/w), or 1% to 5% (w/w), of the polymer, including any range therebetween.

In some embodiments, the minor phase comprises 0.5% to 20% (w/w), 0.5% to 15% (w/w), 0.9% to 15% (w/w), 1% to 15% (w/w), 10% to 15% (w/w), 15% to 20% (w/w), 5% to 10% (w/w),), 0.5% to 10% (w/w), 0.9% to 10% (w/w), 1% to 10% (w/w), 5% to 10% (w/w), 0.5% to 5% (w/w), 0.9% to 5% (w/w), or 1% to 5% (w/w), of the active agent, including any range therebetween.

In some embodiments, the ratio of the major phase and the minor phase is 5:1 to 1:1 (w/w), 4:1 to 1:1 (w/w), 3:1 to 1:1 (w/w), or 2:1 to 1:1 (w/w), including any range therebetween. In some embodiments, the ratio of the major phase and the minor phase is 1:1 (w/w).

In some embodiments, the major phase comprises oil. In some embodiments, the minor phase comprises methyl ethyl ketone (MEK), acetone, n-methyl-2-pyrrolidone (NMP), methylisobutylketone, dichloromethane or any combination thereof.

In another aspect, there is a method of manufacturing the particle of the invention. In some embodiments, the method comprising the steps of: (i) providing a first solution comprising 1% to 50% (w/w) of the viscoelastic polymer and 0.1 to 90% (w/w) of the active agent; (ii) providing a second solution comprising 0.1 to 10% w/w of the hydrophobic metal oxide nanoparticles; and (iii) mixing the first solution and the second solution under appropriate conditions, thereby obtaining a plurality of particles dispersed within the first solution.

In some embodiments, any one of the first solution and the second solution independently comprises an organic solvent, an aqueous solvent or both.

In some embodiments, the method further comprises precipitating the plurality of particles. In some embodiments, precipitating is by filtration, centrifugation or both. In some embodiments, the method further comprises collecting the plurality of particles.

In some embodiments, the method further comprises evaporating any one of the first solution and the second solution.

In some embodiments, the method comprises providing a solution comprising 1% to 50% (w/w) of the viscoelastic polymer and 0.1 to 90% (w/w) of the active agent, and 0.1 to 10% w/w of the hydrophobic metal oxide nanoparticles, wherein the viscoelastic polymer and the active agent are water soluble. In some embodiments, the solution comprises a mixture of an aqueous solution and an oil. In some embodiments, the solution comprises a 30:70 mixture of an aqueous solution and an oil. In some embodiments, the solution comprises an aqueous minor phase and an oil major phase. In some embodiments, the oil phase comprises an organic solution.

In some embodiments, the oil comprises a water-immiscible organic solvent. In some embodiments, the oil is as described herein. In some embodiments, the method comprises providing an oil solution comprising 1% to 50% (w/w) of the viscoelastic polymer 0.1 to 10% w/w of the hydrophobic metal oxide nanoparticles; and mixing the oil solution with an aqueous solution comprising 0.1 to 90% (w/w) of the active agent, so as to form a water in oil emulsion. In some embodiments, mixing is for forming the plurality of particles dispersed within the oil solution. In some embodiments, the plurality of particles comprise water in the particle core. In some embodiments, the method is for encapsulating a water-soluble active agent within the particle of the invention. In some embodiments, the method further comprises step (iv) of evaporating water from the particles. In some embodiments, a boiling point of the active agent (e.g. a hydrophilic or water-miscible agent) is greater than a boiling point of water.

In some embodiments, the method comprising the steps of: (i) providing a first organic solution comprising 1% to 50% (w/w) of the viscoelastic polymer and 0.1 to 90% (w/w) of the active agent; (ii) providing a second aqueous solution comprising 0.1 to 10% w/w of the hydrophobic metal oxide nanoparticles; and (iii) mixing the first solution and the second solution. In some embodiments, the method is for forming a plurality of particles dispersed within an aqueous solution. In some embodiments, the plurality of particles comprise an organic solvent in the particle core. In some embodiments, the method is for encapsulating a hydrophobic (i.e. water insoluble) active agent within the particle. In some embodiments, a boiling point of the organic solvent is less than a boiling point of the active agent (e.g. a hydrophobic agent).

In some embodiments, the method comprises providing an oil in oil emulsion comprising providing a first organic solution comprising 1% to 50% (w/w) of the viscoelastic polymer and 0.1 to 10% w/w of the hydrophobic metal oxide nanoparticles; and providing a second organic solution comprising 0.1 to 90% (w/w) of the active agent. In some embodiments, the method is for forming a plurality of particles dispersed within the second organic solution. In some embodiments, the second organic solution comprises an oil (e.g. mineral oil) and the first organic solution comprises a polar organic solvent (e.g. acetone). In some embodiments, the plurality of particles comprise a polar organic solvent in the particle core. In some embodiments, the method is for encapsulating a lipophilic (i.e. oil-soluble) active agent within the particle. In some embodiments, a boiling point of the polar organic solvent is less than a boiling point of the active agent (e.g. a lipophilic agent).

In some embodiments, evaporating is by applying any of vacuum, heat, or both.

In some embodiments, the ratio of the first solution to the second solution is 5:1 to 1:5 (w/w).

In some embodiments, the polar organic solvent comprises acetone, methyl ethyl ketone (MEK), n-methyl-2-pyrrolidone (NMP), methylisobutylketone, ethyl acetate, and a nitrile, or any combination thereof.

In some embodiments, the mixing is by applying high shear mixing, ultrasonication, overhead stirring, homogenizing, or a combination thereof.

In some embodiments, the steps (i) to (iii) of the method are performed at a temperature below the boiling point of any of the first solvent, the second solvent or both. In some embodiments, the steps (i) to (iii) of the method are performed at a temperature between 0 and 50° C.

In another aspect of the invention, there is a method for controlling a pest or reducing growth thereof, comprising providing the coated substrate (e.g. article) of the invention and applying the coated substrate of the invention an area under cultivation infested with the pest, thereby controlling or reducing growth of the pest. In some embodiments, the pest is selected from a fungi, a microbe, an insect, a virus, a mold, and a weed including any combination thereof. In some embodiments, the coated substrate (e.g. article) of the invention comprises or encapsulates a pesticidal effective amount of an active agent, as described herein. In some embodiments, the method comprises locating or providing the article of the invention in close proximity to a cultivated plant. In some embodiments, providing is pre-planting, pre-seeding, post-planting, post-seeding, pre-harvesting, post harvesting or any combination thereof.

In some embodiments, the article of the invention is located in contact with or in close proximity to a plant, and/or a part of the plant under cultivation (e.g. target location). In some embodiments, the article of the invention is located within the area under cultivation (e.g. target location). In some embodiments, the article of the invention is located at the target location during the whole cultivation cycle, or at least a part thereof. In some embodiments, the article of the invention is located in contact with or in close proximity to an edible matter under storage, e.g. harvested fruits or vegetables.

In some embodiments, the method is for killing a plant pathogen or for reducing plant pathogen load. In some embodiments, the method is for killing a pathogen or reducing growth thereof by providing the article of the invention at the target location, as described hereinabove.

In some embodiments, the pest is a pathogenic parasite. In some embodiments, the pathogen is an insect. In some embodiments, the pathogen is an aphid. According to some embodiments of the present invention, the disclosed compositions are for use in the reducing growth or for complete inhibition of a pathogen.

In some embodiments, the term “reducing”, or any grammatical derivative thereof, indicates that at least 20%, 30%, 40%, 50%, 60%, 70%, 80%, 90%, or more, reduction of growth or even complete growth inhibition in a given time as compared to the growth in that given time of the pathogen not being exposed to the treatment as described herein. In some embodiments, the term “completely inhibited”, or any grammatical derivative thereof, refers to 100% arrest of growth in a given time as compared to the growth in that given time of the pathogen not being exposed to the treatment as described herein. In some embodiments, the terms “completely inhibited” and “eradicated” including nay grammatical form thereof, are used herein interchangeably.

### General

As used herein the term “about” refers to ±10%.

The terms “comprises”, “comprising”, “includes”, “including”, “having” and their conjugates mean “including but not limited to”.

The term “consisting of means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

The term “at least partially” as used herein refers to at least 30%, at least 50%, at least 70%, at least 80%, at least 90%, including any range or value therebetween.

The term “substantially”, as used herein refers to at least 90%, at least 93%, at least 95%, at least 97%, at least 99%, at least 99.9% including any range or value therebetween.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

As used herein the term “method” refers to manners, means, techniques and procedures for accomplishing a given task including, but not limited to, those manners, means, techniques and procedures either known to, or readily developed from known manners, means, techniques and procedures by practitioners of the chemical, pharmacological, biological, biochemical and medical arts.

As used herein, the term “treating” includes abrogating, substantially inhibiting, slowing or reversing the progression of a condition, substantially ameliorating clinical or aesthetical symptoms of a condition or substantially preventing the appearance of clinical or aesthetical symptoms of a condition.

In one embodiment, the term “alkyl” comprises an aliphatic hydrocarbon including straight chain and branched chain groups. Preferably, the alkyl group has 21 to 100 carbon atoms, and more preferably 21-50 carbon atoms. Whenever a numerical range; e.g., “21-100”, is stated herein, it implies that the group, in this case the alkyl group, may contain 21 carbon atoms, 22 carbon atoms, 23 carbon atoms, etc., up to and including 100 carbon atoms.

In one embodiment, the term “long alkyl” comprises an alkyl having at least 20 carbon atoms in its main chain (the longest path of continuous covalently attached atoms). A short alkyl therefore has 20 or less main-chain carbons. In one embodiment, an alkyl can be substituted or unsubstituted. In one embodiment, the term “alkyl”, as used herein, also encompasses saturated or unsaturated hydrocarbon, hence this term further encompasses alkenyl and alkynyl.

In one embodiment, the term “alkenyl” describes an unsaturated alkyl, as defined herein, having at least two carbon atoms and at least one carbon-carbon double bond. The alkenyl may be substituted or unsubstituted by one or more substituents, as described hereinabove. In one embodiment, the term “alkynyl”, as defined herein, is an unsaturated alkyl having at least two carbon atoms and at least one carbon-carbon triple bond. The alkynyl may be substituted or unsubstituted by one or more substituents.

In one embodiment, the term “unsaturated” describes a compound containing one or more unsaturated bond(s). In some embodiments, an unsaturated bond refers to a double bond, and/or to a triple bond.

In one embodiment, the term “cycloalkyl” describes an all-carbon monocyclic or fused ring (i.e., rings which share an adjacent pair of carbon atoms) group where one or more of the rings does not have a completely conjugated pi-electron system. The cycloalkyl group may be substituted or unsubstituted.

In one embodiment, the term “aryl” describes an all-carbon monocyclic or fused-ring polycyclic (i.e., rings which share adjacent pairs of carbon atoms) groups having a completely conjugated pi-electron system. In one embodiment, an aryl group may be substituted or unsubstituted.

In one embodiment, the term alkoxy” describes both an —O-alkyl and an cycloalkyl group. In one embodiment, the term “aryloxy” describes an —O-aryl. In one embodiment, the term alkyl, cycloalkyl and aryl groups in the general formulas herein may be substituted by one or more substituents, whereby each substituent group can independently be, for example, halide, alkyl, alkoxy, cycloalkyl, alkoxy, nitro, amine, hydroxyl, thiol, thioalkoxy, thiohydroxy, carboxy, amide, aryl and aryloxy, depending on the substituted group and its position in the molecule.

In one embodiment, “halide”, “halogen” or “halo” describes fluorine, chlorine, bromine or iodine. In one embodiment, “haloalkyl” describes an alkyl group as defined herein, further substituted by one or more halide(s). In one embodiment, “haloalkoxy” describes an alkoxy group as defined herein, further substituted by one or more halide(s). In one embodiment, the term “hydroxyl” or “hydroxy” describes a —OH group. In one embodiment, the term “thiohydroxy” or “thiol” describes a —SH group. In one embodiment, the term “thioalkoxy” describes both an —S-alkyl group, and a —S-cycloalkyl group. In one embodiment, the term “thioaryloxy” describes both an —S-aryl and a —S-heteroaryl group. In one embodiment, the term “amine” describes a —NR′R″ group, with R′ and R″. In one embodiment, the term “heteroaryl” describes a monocyclic or fused ring (i.e., rings which share an adjacent pair of atoms) group having in the ring(s) one or more atoms, such as, for example, nitrogen, oxygen and sulfur and, in addition, having a completely conjugated pi-electron system. Examples, without limitation, of heteroaryl groups include pyrrole, furane, thiophene, imidazole, oxazole, thiazole, pyrazole, pyridine, pyrimidine, quinoline, isoquinoline and purine.

In one embodiment, the term “heteroalicyclic” or “heterocyclyl” describes a monocyclic or fused ring group having in the ring(s) one or more atoms such as nitrogen, oxygen and sulfur. The rings may also have one or more double bonds. In one embodiment, the rings do not have a completely conjugated pi-electron system. Representative examples are piperidine, piperazine, tetrahydrofurane, tetrahydropyrane, morpholino and the like.

In one embodiment, the term “carboxy” or “carboxylate” describes a —C(═O)—OR′ group, where R′ is hydrogen, alkyl, cycloalkyl, alkenyl, aryl, heteroaryl (bonded through a ring carbon) or heteroalicyclic (bonded through a ring carbon).

In one embodiment, the term “carbonyl” describes a —C(═O)—R′ group, where R′ is as defined hereinabove. In one embodiment, the above-terms also encompass thio-derivatives thereof (thiocarboxy and thiocarbonyl).

In one embodiment, the term “thiocarbonyl” describes a —C(═S)—R′ group, where R′ is as defined hereinabove. In one embodiment, the term “thiocarboxy” group describes a —C(═S)—OR′ group, where R′ is as defined herein. In one embodiment, the term sulfinyl” group describes an —S(═O)—R′ group, where R′ is as defined herein. In one embodiment, the term sulfonyl” or “sulfonate” group describes an —S(═O)2-R′ group, where R′ is as defined herein. In one embodiment, the term “carbamyl” or “carbamate” group describes an —OC(═O)—NR′R″ group, where R′ is as defined herein and R″ is as defined for R′.

In one embodiment, the term “nitro” group refers to a —NO2 group. In one embodiment, the term “cyano” or “nitrile” group refers to a refers to a —N3 group. In one embodiment, the term “sulfonamide” refers to a —S(═O)2-NR′R″ group, with R′ and R″ as defined herein.” refers to a —N3 group. In one embodiment, the term “sulfonamide” refers to a —S(═O)2-NR′R″ group, with R′ and R″ as defined herein.

In one embodiment, the term “phosphonyl” or “phosphonate” describes an —O—P(═O)(OR′)2 group, with R′ as defined hereinabove. In one embodiment, the term “phosphinyl” describes a —PR′R″ group, with R′ and R″ as defined hereinabove.

In one embodiment, the term “alkaryl” describes an alkyl, as defined herein, which substituted by an aryl or a heteroaryl, as described herein. In one embodiment, alkaryl is benzyl.

In one embodiment, the term “heteroaryl” describes a monocyclic or fused ring (i.e., rings which share an adjacent pair of atoms) group having in the ring(s) one or more atoms, such as, for example, nitrogen, oxygen and sulfur and, in addition, having a completely conjugated pi-electron system. Examples, without limitation, of heteroaryl groups include pyrrole, furane, thiophene, imidazole, oxazole, thiazole, pyrazole, pyridine, pyrimidine, quinoline, isoquinoline and purine. The heteroaryl group may be substituted or unsubstituted by one or more substituents, as described hereinabove. Representative examples are thiadiazole, pyridine, pyrrole, oxazole, indole, purine and the like.

In one embodiment, the terms “halo” and “halide”, which are referred to herein interchangeably, describe an atom of a halogen, that is fluorine, chlorine, bromine or iodine, also referred to herein as fluoride, chloride, bromide and iodide. In one embodiment, the term “haloalkyl” describes an alkyl group as defined above, further substituted by one or more halide(s).

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Various embodiments and aspects of the present invention as delineated hereinabove and as claimed in the claims section below find experimental support in the following examples.

### Examples

### Preparation of Polymer Solutions:

The poly vinyl alcohol was weighed (according to the polymer concentration) and uniformly dispersed in water (100 mL) at 80° C.

### Preparation of Exemplary (O/O) Emulsions of the Invention:

In this study, various emulsions have been prepared by changing the concentrations of hydrophobic silica (3, 4, 5 wt %), of the polymer (5, 10, 30 wt %), and of the oil volume ratio in the final emulsion (from 1 to 9 mL).

3,4 and 5 wt % hydrophobic silica dispersed in oil (mineral oil or vegetable oil, such as canola oil) in the presence of 5, 10 and 30 wt % polymer according to MEK volume were investigated. The silica dispersion was prepared as follows; required mass of hydrophobic silica was placed in the vial followed by addition of the required mass of oil. The mixture was sonicated for 5 min. The required volume of a MEK or acetone and amount of polymer was then added. The mixture was sonicated for 10 min using an ultra-sonication at 25% amplitude.

### Preparation of an Exemplary (W/O) Emulsion of the Invention:

In this study, the emulsions were prepared by changing the silica (1, 2, 3, 4, and 5 wt %), polymer (1, 2, 3, 4, 5 wt %) and both oil water ratio (1-9 mL). silica dispersed oil in the presence of 5 polymer according to water volume were investigated. The silica dispersion was prepared as follows; required mass of particles was placed in the vial followed by addition of the required mass of oil. The mixture was sonicated for 5 min. The required volume of a water (polymer dispersed in water) was then added. The mixture was sonicated for 10 min using an ultra-sonication at 25% amplitude.

The inventors successfully implemented a mixture of PVA or PVC and polyacrylate as the viscoelastic polymer component of the O/O emulsions described herein. Various w/w concentrations of the polymer ranging between 1 and 30% have been utilized for the preparation of the O/O emulsions described herein. Furthermore, the inventors successfully implemented PVA (between 1 and 5% w/w) as the viscoelastic polymer component of the W/O emulsions described herein.

The inventors successfully utilized a viscoelastic polymer solution in a ketone-based solvent for the preparation of stable O/O and W/O Pickering emulsions stabilized by hydrophobic nanoparticles such as halogenated (e.g. fluorinated, and/or chlorinated) silica particles and/or methyl-silylated silica particles. Pickering emulsions exemplified herein, have been successfully prepared by utilization of between 1 and 5% by weight of the hydrophobic nanoparticles.

Various polymers (such as PVC, PVA and polyacrylate, including mixtures thereof) at a concentration ranging from 1 to 30% by weight of the composition, have been successfully implemented for the preparation of exemplary Pickering emulsions of the invention. Furthermore, the emulsions disclosed herein stably encapsulated various active agents (such as Thymol), at a concentration ranging from 0.001 to 10% by weight of the emulsion.

Various commercially available hydrophobic silica particles can be utilized for the preparation of the compositions and coatings disclosed herein (e.g. Aerosil). In an exemplary embodiment, multifunctional (fluorinated and chlorinated) halogenated silica has been used for the preparation of stable O/O Pickering emulsions, and fluorinated silica has been used for the preparation of stable W/O Pickering emulsions, wherein fluorinated and multifunctional silica has been prepared as described hereinbelow.

### Synthesis of Multifunctional Silica Nanoparticles (NP)s:

1 g Silica NPs was dispersed in 40 mL of ethanol by mechanical mixing. 32.64 mmol (1.14 g) of NH4OH (28 wt %) was added slowly to the solution. After ten minutes, 0.98 mmol (0.5 g, 0.67 ml) of 1H,1H,2H,2H-Perfluorooctyltriethoxysilane (FAS) and 1.28 mmol (0.5 g, 0.50 ml) of Trichloro(octadecyl)silane were added to the solution. The reaction was performed at ambient temperature for 45 min followed by vigorous stirring (800 rpm). The multi-functional silica particles were collected by four cycles of centrifugation followed by ethanol rinsing. The NPs were then dried in a vacuum oven at 35° C. for ca. 3 hours.

### Synthesis of Fluorinated Silica NPs:

1 g Silica NPs was dispersed in 40 mL of ethanol by mechanical mixing. 32.64 mmol (1.14 g) of NH4OH (28 wt %) was added slowly to the solution. After ten minutes, 2.58 mmol (1.32 g) of 1H,1H,2H,2H-Perfluorooctyltriethoxysilane (FAS) were added to the solution. The reaction was performed at ambient temperature for 45 min followed by vigorous stirring (800 rpm). The fluorocarbon functionalized silica particles were collected by four cycles of centrifugation followed by ethanol rinsing. The NPs were then dried in a vacuum oven at 35° C. for ca. 3 hours.

Exemplary Pickering emulsions of the invention were stable for several months (between 2 and 6 months).

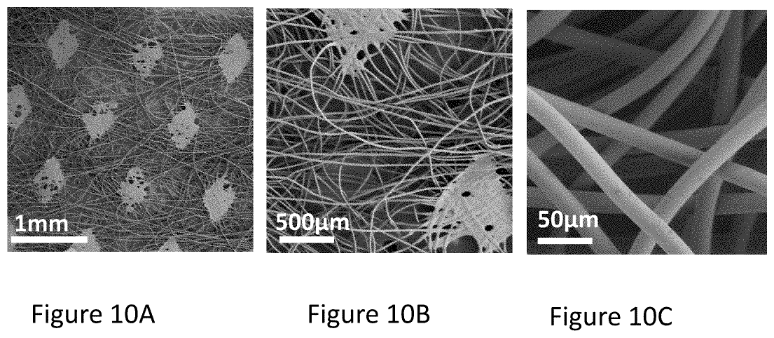

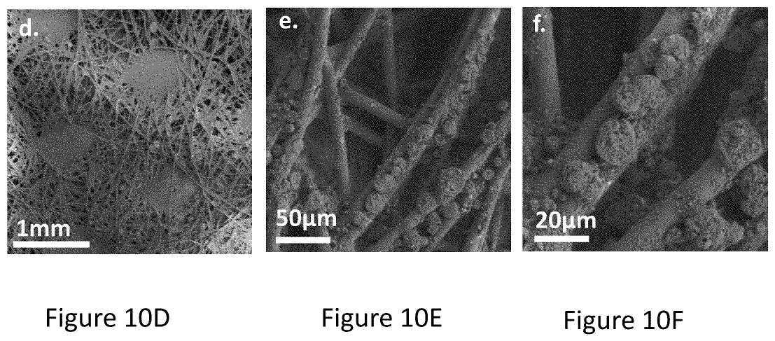

Moreover, exemplary compositions of the invention have been successfully applied on various polymeric substrates including a polyolefin (e.g. polypropylene) based film, and on a non-woven substrate (such as Avgol©), resulting in a stable coating (see FIG. 10) upon subsequent drying.

### Preparation of Coatings:

As prepared emulsions were applied on the surface via spin or roll coating method. In order to enable rapid evaporation of emulsions, the surfaces were placed in hot air oven maintained at 60° C. for 3±1 hour.

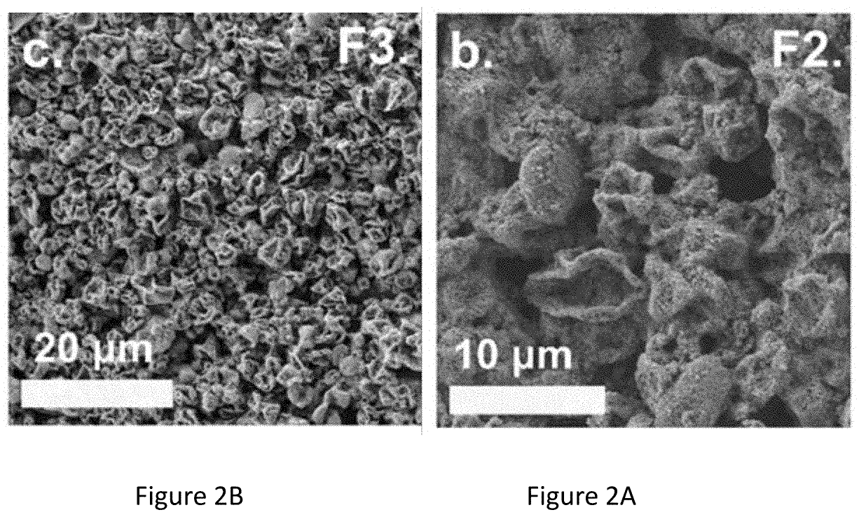

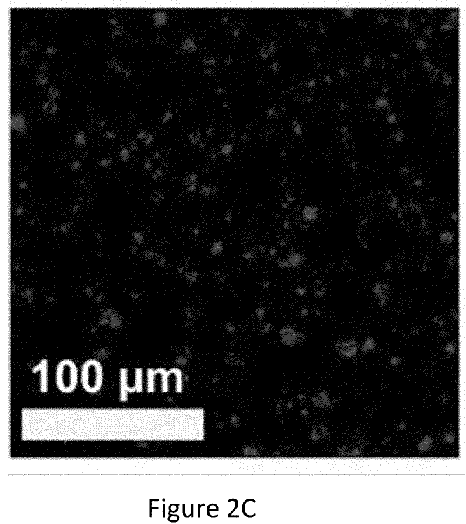

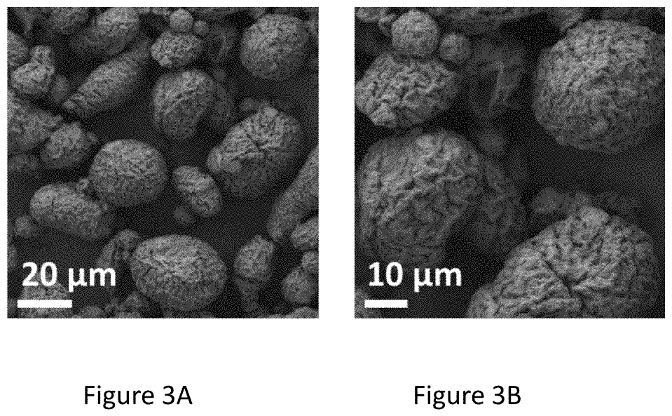

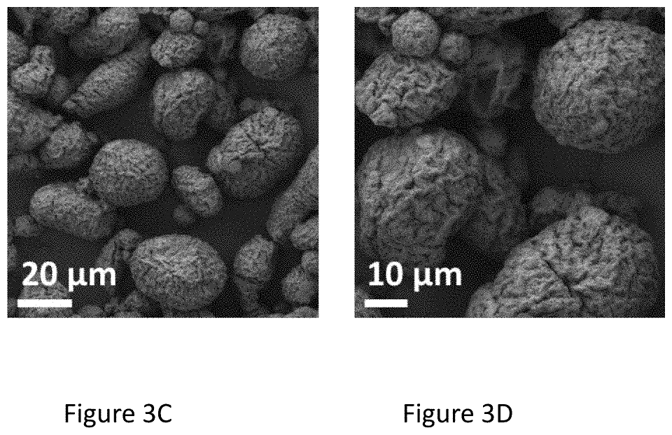

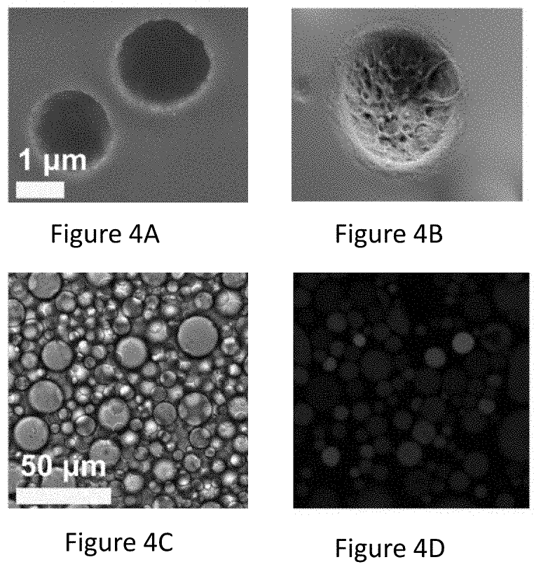

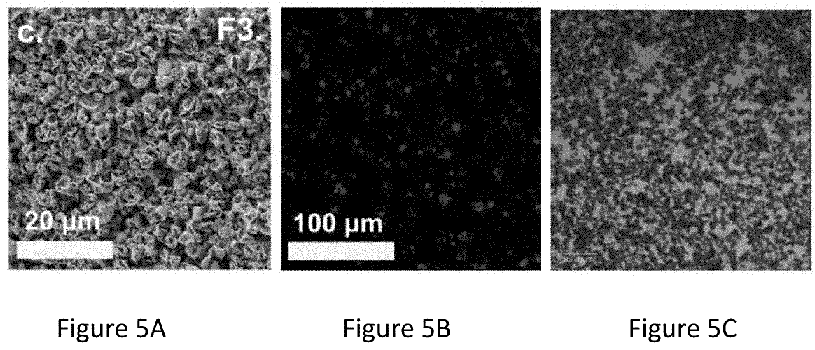

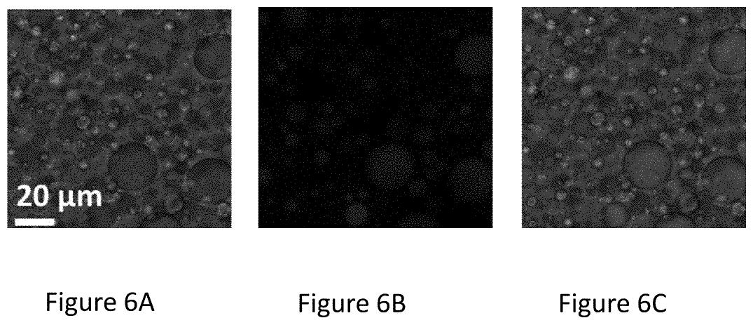

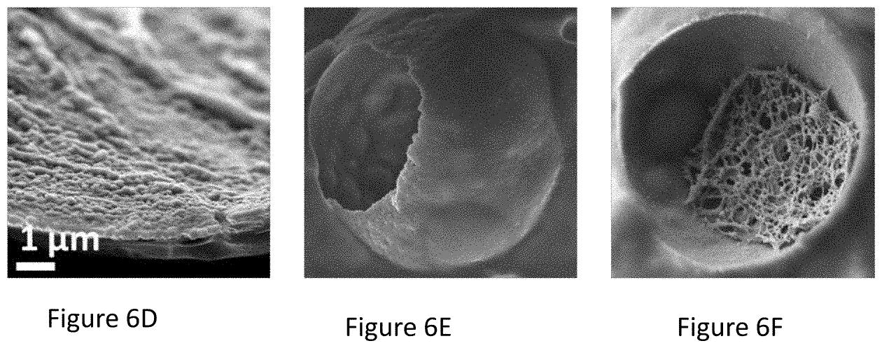

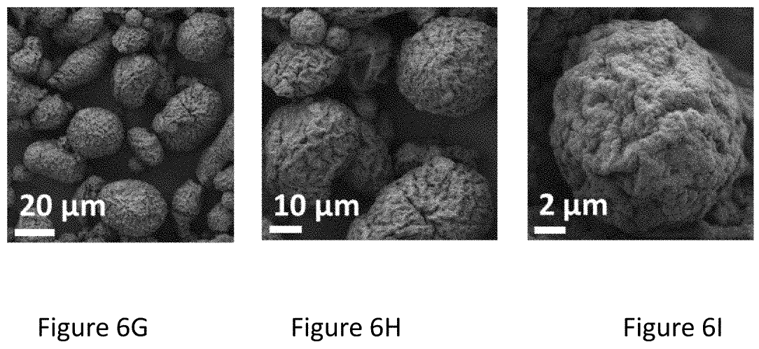

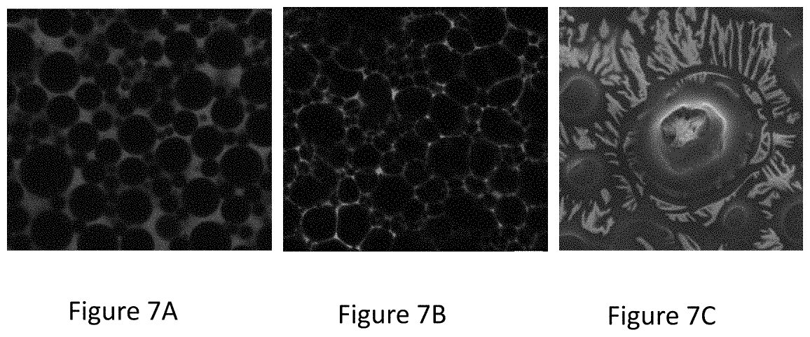

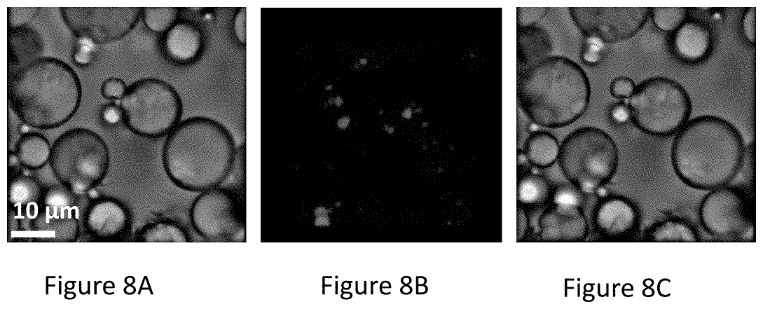

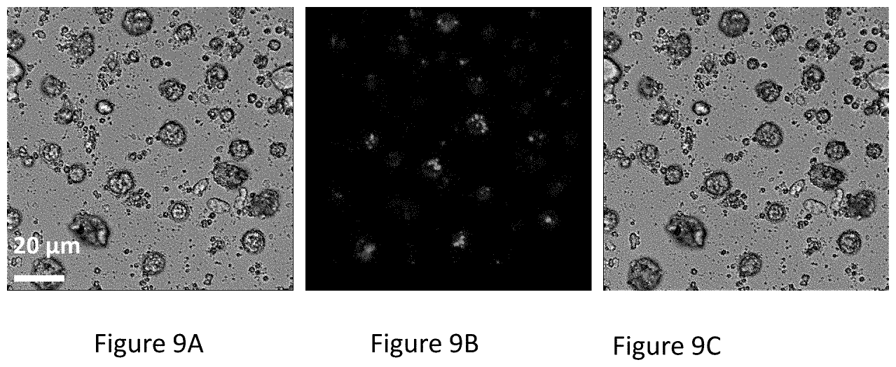

It has been demonstrated (see FIG. 9 and FIG. 3), that the coating is formed by a plurality of intact dry particles, substantially retaining its shape upon drying the substrate in contact with the composition of the invention. Moreover, the dry particle stably encapsulated the active agent therewithin (see FIGS. 2C, 5C).

By implementing a solvent (e.g. minor phase) having a boiling point lower than the boiling point of the active agent, the inventors successfully coated a substrate with an active coating layer comprising a plurality of dry particles encapsulated significant amount of the active agent (essential oils, such as Thymol) within the dry particle's core.

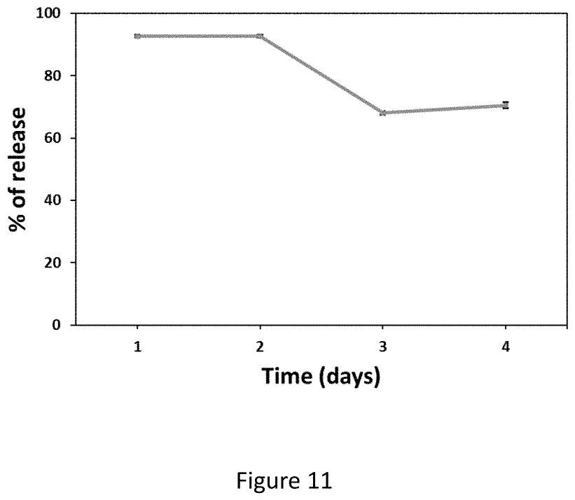

It has been further demonstrated that the coating is capable of gradually releasing the encapsulated active agent (e.g. essential oil) within a time period of several days (see FIG. 11) to several months.

The release of the encapsulated active agent (e.g. essential oil) from the active coating has been evaluated and quantified by implementing methanol extraction procedure and by analyzing the extracts on GC-MS, as described hereinbelow.

### Gc-MS Analysis:

The stock standard solutions of thymol were prepared in methanol at a concentration of 2 mg mL⁻¹. A gas chromatograph interfaced with a mass spectrometer (GC-MS) was used for analysis of thymol. Selected ion monitoring (SIM) was employed with the following ions selected for quantification: m/z 135,150 for thymol.

Chromatographic conditions were optimized by analyzing 1 μL aliquots of standard solutions prepared in methanol at a concentration of 2 mg mL⁻¹ (split ratio 1:100). Thymol and samples were separated by using a fused-silica capillary column (HP-5 ms®,5% phenyl methyl siloxane, 30 m×0.25 mm i.d. and 0.25 μm film thicknesses, Agilent, USA). The analyses were carried out by using nitrogen as carrier gas at a flow rate of 1 mL min⁻¹, injector, detector interface temperature set at 200° C., and column temperature starting at 100° C. (1 min) and programmed to increase 100° C. min⁻¹ to 200° C. (5 min), resulting in a total running time of 6 min.

Extraction procedure for encapsulated Thymol from a substrate (e.g. polymeric substrate) coated by a coating as described herein:

10 mL of methanol were placed in 20 mL vials containing 5 X5 cm of encapsulated Thymol coated surface. The vials were closed and sonicated for 20 mins followed by filter the solvent through 0.22 μm syringe. The vials were sealed with PTFE/silicone septa (Supelco, USA). Next, the needle of the device was injected into the vial and the sample was exposed to the headspace. After that immediately introduced into the chromatographic system for desorption of the analytes. The experiments were performed in triplicate.

Additionally, physical stability of the resulting coatings has been tested via abrasion test, showing high abrasion stability of the coatings disclosed herein.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

1. A composition comprising a plurality of core-shell particles dispersed within a major phase, wherein each core-shell particle comprises:
a. a liquid core comprising (i) 5% to 50% weight per weight (w/w) of a viscoelastic polymer, (ii) 0.1% to 50% w/w of an active agent, and a solvent; and
b. a shell comprising hydrophobic metal oxide nanoparticles stabilizing the core; wherein said major phase comprises an oil or an aqueous solution, wherein said solvent is a ketone solvent; and wherein said major phase is immiscible with said solvent.

2. The composition of claim 1, wherein a w/w ratio between said major phase and said solvent within said composition is between 1:5 and 5:1.

3. The composition of claim 1, wherein said shell further comprises said viscoelastic polymer at a concentration of between 1 to 50% by weight of said shell, and wherein said viscoelastic polymer has a glass transition temperature (Tg) above 30° C., and wherein said viscoelastic polymer is soluble within said solvent and is insoluble within said major phase; optionally wherein said viscoelastic polymer is a viscous polymer having a viscosity at 25° C. between 30 and 200 cP.

4. (canceled)

5. The composition of claim 1, wherein said active agent has a boiling temperature greater than a boiling temperature of said solvent, optionally above 60° C., optionally wherein said core-shell particle has a diameter of 0.5 μm to 500 μm, and further optionally wherein said shell has a thickness of 10 nm to 100 μm.

6. (canceled)

7. (canceled)

8. The composition of claim 1, wherein said viscoelastic polymer comprises a polyacrylate-co-PVC, polysiloxane, polyisocyanate, polyvinylchloride (PVC), a vinyl-based polymer, polymetacrylate, polysilane, polysilazane, polyvinyl alcohol (PVA), poly (2ethyl-2-oxazoline), carboxymethyl cellulose (CMC), and dimethylsiloxane, or any copolymer or a combination thereof.

9. The composition of claim 1, wherein said active agent comprises an essential oil, a herbicide, a pesticide, a fungicide, or any combination thereof.

10. The composition of claim 1, wherein said hydrophobic metal oxide nanoparticles comprises a chemical modification covalently bound to a metal oxide, optionally wherein said metal oxide is selected from the group consisting of nanoclay, SiO₂, TiO₂, Al₂O₃, Fe₂O₃, ZnO, and ZrO or any combination thereof optionally wherein said chemical modification is selected from the group consisting of (C1-C20) alkyl, (C1-C20) alkylsilyl, halosilyl, phenyl, thiol group, vinyl, fluoroalkyl, haloalkyl, halogen, epoxy, a cycloalkyl, an alkenyl, a haloalkenyl, an alkyne, an ether, a silyl group, a siloxane group, and a thioether or any combination thereof.

11. (canceled)

12. The composition of claim 10, wherein said chemical modification is selected from the group consisting of (C1-C20) alkyl, (C1-C20) alkylsilyl, halosilyl, phenyl, thiol group, vinyl, fluoroalkyl, haloalkyl, halogen, epoxy, a cycloalkyl, an alkenyl, a haloalkenyl, an alkyne, an ether, a silyl group, a siloxane group, and a thioether or any combination thereof.

13. The composition of claim 1, wherein a ratio of said hydrophobic metal oxide nanoparticles to said viscoelastic polymer within said composition is between 1:5 and 5:1 (w/w); optionally wherein a ratio of said viscoelastic polymer to said active agent within said composition is between 1:0.01 and 1:0.1 (w/w).

14. (canceled)

15. The composition of claim 1, comprising between 0.1% and 10% (w/w) of said hydrophobic metal oxide nanoparticles, optionally wherein a w/w concentration of said viscoelastic polymer within said composition is between 0.1 and 50%, optionally wherein a w/w concentration of said active agent within said composition is between 0.01 and 10%.

16. (canceled)

17. (canceled)

18. The composition of claim 1, wherein said ketone solvent is selected from the group consisting of acetone, methyl ethyl ketone (MEK), and methylisobutylketone, or any combination thereof; optionally wherein said oil comprises a vegetable oil, a mineral oil, and a lipid, or any combination thereof.

19. (canceled)

20. (canceled)

21. (canceled)

22. The composition of claim 1, wherein said composition comprises between 1 and 30% w/w of said viscoelastic polymer selected from PVA, PVC, and polyacrylate, including any mixture thereof; between 0.5 and 10% w/w of said hydrophobic metal oxide nanoparticle, and wherein said ketone solvent comprises acetone or MEK, optionally wherein said composition is a coating composition.

23. (canceled)

24. An article comprising: a substrate, and a plurality of dry particles in contact with said substrate, wherein each of said plurality of dry particles comprising a shell and a core, wherein said core comprises (i) 1% to 90% (w/w) of a viscoelastic polymer, and (ii) 0.1% to 50% (w/w) of an active agent and; said shell comprises hydrophobic metal oxide nanoparticles in contact with the viscoelastic polymer; and wherein said active agent comprises an essential oil, a herbicide, a pesticide, a fungicide, or any combination thereof.

25. The article of claim 24, wherein said plurality of particles is in a form of a coating layer on top of said substrate; optionally wherein said article is capable of releasing said active agent for a time period of at least 24 h; optionally wherein said plurality of particles is stably bound to said substrate, and wherein said coating layer is stable at a temperature range of −100° C. to 200° C.; optionally wherein said plurality of dry particles is in a form of a hollow sphere, and is characterized by a diameter of between 0.5 μm to 500 μm; and wherein said shell has a thickness of 10 nm to 100 μm.

26. (canceled)

27. (canceled)

28. (canceled)

29. The article of claim 24, wherein said viscoelastic polymer has a glass transition temperature (Tg) above 30° C., is characterized by a viscosity of between 30 and 200 cP at 25° C.; optionally wherein each of said plurality of dry particles comprises between 1% and 90% (w/w) of said hydrophobic metal oxide nanoparticles, optionally wherein said hydrophobic metal oxide nanoparticles comprise comprises a chemical modification covalently bound to a metal oxide and wherein said chemical modification is selected from the group consisting of silyl, methyl silyl, dimethyl silyl, haloalkyl silyl, and halosilyl, or any combination thereof.

30. (canceled)

31. (canceled)

32. (canceled)

33. (canceled)

34. The article of claim 24, wherein said substrate is selected from, a polymeric substrate, a woven polymeric substrate, a non-woven polymeric substrate, a glass substrate, a metallic substrate, a paper substrate, a brick wall, a sponge, a textile, a non-woven fabric, or wood; wherein said coating layer is characterized by an average thickness of 1 to 500 μm; and wherein said coating layer is characterized by a water contact angle (WCA) in the range of 115° to 180°, and optionally by a roll-off (RA) angle of less than 30°.

35. (canceled)

36. (canceled)

37. A method for manufacturing the composition of claim 1, comprising the steps of:
a. providing a first composition comprising 1% to 50% (w/w) of the viscoelastic polymer and 0.1 to 90% (w/w) of the active agent dissolved within the ketone solvent;
b. providing a second composition comprising 0.1 to 10% w/w of said hydrophobic metal oxide nanoparticles and said major phase; and
c. mixing said first composition and said second composition under appropriate conditions, thereby obtaining said plurality of core-shell particles dispersed within said major phase.

38. The method of claim 37, wherein said method further comprising evaporating said ketone solvent optionally wherein said evaporating is by applying any of vacuum, heat, or both.

39. (canceled)

40. The method of claim 37, wherein said ketone solvent comprises any one of acetone, methyl ethyl ketone (MEK), and methylisobutylketone, or any combination thereof, and wherein said ketone solvent has a boiling point less than a boiling point of said active agent.

41. (canceled)

42. The method of claim 37, wherein said mixing is high shear mixing, ultrasonication, overhead stirring, homogenizing, or a combination thereof; and wherein the ratio of said first composition to said second composition is from 5:1 to 1:5 (w/w).

43. (canceled)
